(19) United States
(12) Patent Application Publication
(10) Pub. No.: US 2026/0250505 A1
(43) Pub. Date: Aug. 27, 2026

(54) RESIN COMPOSITION, PREPREG, METAL-CLAD LAMINATE, AND METHOD FOR PRODUCING SAME

(71) Applicant: AGC INC., Tokyo (JP)

(72) Inventors: Tadashi IWAMOTO, Tokyo (JP); Takuma HIRATA, Tokyo (JP); Yu TAKEUCHI, Tokyo (JP); Masahito YAGISHITA, Tokyo (JP)

(73) Assignee: AGC INC., Tokyo (JP)

(21) Appl. No.: 19/648,484

(22) Filed: Apr. 15, 2026

Related U.S. Application Data
(63) Continuation of application No. PCT/JP2024/036775, filed on Oct. 16, 2024.

(30) Foreign Application Priority Data
Oct. 16, 2023 (JP) 2023-178264
Apr. 24, 2024 (JP) 2024-070640

(51) Int. Cl. C08L 65/00; B32B 5/26; B32B 15/085; B32B 15/20; B32B 37/10; C08J 5/24; C08K 5/5397; C08K 7/18; C08L 71/12

(52) U.S. Cl. CPC C08L 65/00; B32B 5/26; B32B 15/085; B32B 15/20; C08J 5/244; C08K 5/5397; C08K 7/18; C08L 71/126; B32B 37/10; B32B 2250/04; B32B 2250/40; B32B 2260/023; B32B 2260/046; B32B 2262/101; B32B 2307/20; B32B 2307/3065; C08J 2365/00; C08J 2371/12; C08J 2453/02; C08L 2205/035

(57) ABSTRACT

Provided are a resin composition with excellent electrical properties and flame retardancy, a prepreg, a metal-clad laminate, and a method for producing the same. A resin composition contains at least a resin having an α-olefin structure represented by the following Formula (1), an organophosphorus compound, and a compound having at least one atom selected from the group consisting of an oxygen atom and a nitrogen atom. Also provided are a prepreg, a metal-clad laminate, and a method for producing a metal-clad laminate, using the resin composition.

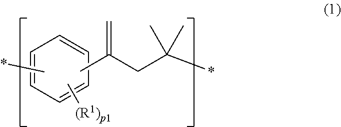

In Formula (1), each R¹ independently represents a C1-C10 hydrocarbon group or a halogenated alkyl group, p1 represents an integer of 0 to 4, and each * represents a bonding position.

### INCORPORATION BY REFERENCE

This application is based upon and claims the benefit of priority from Japanese Patent Application No. 2023-178264 filed on Oct. 16, 2023, Japanese Patent Application No. 2024-070640 filed on Apr. 24, 2024, and PCT application No. PCT/JP2024/036775 filed on Oct. 16, 2024 the disclosure of which is incorporated herein in its entirety by reference.

### BACKGROUND

The present disclosure relates to a resin composition, a prepreg, a metal-clad laminate, and a method for producing the same.

A laminate used for a printed circuit board employed in high-speed communication is required to have further improved performance. The resin composition used for a laminate is required to have various practical performances, including electrical properties.

Japanese Unexamined Patent Application Publication No. 2022-100270 discloses a polymer having an indane structure, based on a specific diisoalkenyl arene, and having sufficient electrical properties.

### SUMMARY

When a polymer having a large amount of the indane structure described in Japanese Unexamined Patent Application Publication No. 2022-100270 is used for a metal-clad laminate, it has been difficult in some cases to achieve both electrical properties and flame retardancy.

The present disclosure has been made in view of the above problems, and an object thereof is to provide a resin composition with excellent electrical properties and flame retardancy, a prepreg, and a metal-clad laminate, and a method for producing the same.

The resin composition, prepreg, metal-clad laminate, and method for producing the same according to the present disclosure are as set forth in the following [1] to [23].
[1] A resin composition containing at least a resin having an α-olefin structure represented by the following Formula (1), an organophosphorus compound, and a compound having at least one atom selected from the group consisting of an oxygen atom and a nitrogen atom,

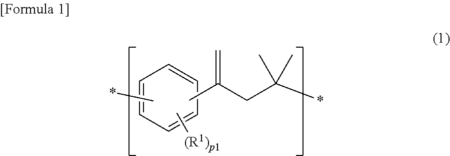

in Formula (1), each R¹ independently represents a C1-C10 hydrocarbon group or a halogenated alkyl group, p1 represents an integer of 0 to 4, and each * represents a bonding position.
[2] The resin composition according to [1], in which an iodine value of the resin is 70 or more and 200 or less.
[3] The resin composition according to [1] or [2], in which a weight average molecular weight Mw of the resin is 2,500 or more and 500,000 or less.
[4] The resin composition according to any one of [1] to [3], in which a content of the α-olefin structure represented by Formula (1) in the resin is 1.0 mmol/g or more and 6.3 mmol/g or less.
[5] The resin composition according to any one of [1] to [4], in which the following parameter FA represented by a content of the α-olefin structure represented by Formula (1), a content of an indane structure represented by the following Formula (2), and a content of an inner olefin structure represented by the following Formula (3) in the resin is 0.39 or more,

FA=[content of α-olefin structure]/([content of inner olefin structure]+[content of indane structure]+[content of α-olefin structure])

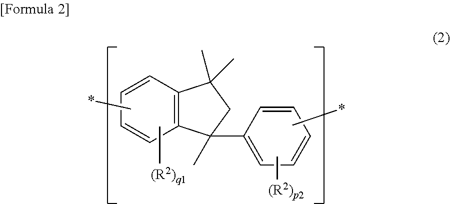

in Formula (2), each R² independently represents a C1-C10 hydrocarbon group or a halogenated alkyl group, p2 represents an integer of 0 to 4, q1 represents an integer of 0 to 3, and each * represents a bonding position,

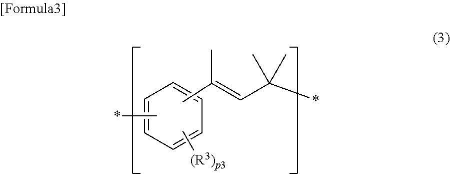

in Formula (3), each R³ independently represents a C1-C10 hydrocarbon group or a halogenated alkyl group, p3 represents an integer of 0 to 4, and each * represents a bonding position.
[6] The resin composition according to any one of [1] to [5], in which the following parameter FT represented by a content of the α-olefin structure represented by Formula (1), a content of an indane structure represented by Formula (2), and a content of an inner olefin structure represented by Formula (3) in the resin is less than 0.58,

FI=[content of indane structure]/([content of inner olefin structure]+[content of indane structure]+[content of α-olefin structure]/2).
[7] The resin composition according to any one of [1] to [6], in which a content of heteroatoms other than the carbon atoms and the hydrogen atoms in the resin is 3 mass % or less.
[8] The resin composition according to [7], in which the resin does not contain the heteroatoms.
[9] The resin composition according to any one of [1] to [8], in which the resin has an olefin structure at a terminal.
[10] The resin composition according to any one of [1] to [9], in which the resin further has a side-chain olefin structure having an olefin structure in a side-chain portion.
[11] The resin composition according to any one of [1] to [10], in which a total content of the α-olefin structure, an olefin structure at a terminal, and a side-chain olefin structure having an olefin structure in a side-chain portion in the resin is 1.8 mmol/g or more.
[12] The resin composition according to any one of [1] to [11], in which a content of an indane structure represented by Formula (2) in the resin is 3.0 mmol/g or less.
[13] The resin composition according to any one of [1] to [12], in which the organophosphorus compound has a solubility of 5 g or less in 100 g of toluene at 25° C.
[14] The resin composition according to any one of [1] to [13], in which the organophosphorus compound is incompatible with the resin.
[15] The resin composition according to any one of [1] to [14], in which a melting point of the organophosphorus compound is 240° C. or higher.
[16] The resin composition according to any one of [11] to [15], in which the organophosphorus compound has a phosphine oxide structure or a phosphinic acid structure.
[17] The resin composition according to any one of [1] to [16], in which a number average molecular weight Mn of the compound having at least one atom selected from the group consisting of an oxygen atom and a nitrogen atom is 300 to 50,000.
[18] The resin composition according to any one of [1] to [17], in which the compound having at least one atom selected from the group consisting of an oxygen atom and a nitrogen atom contains a radical-polymerizable group.
[19] The resin composition according to any one of [1] to [18], in which a total content of oxygen atoms and nitrogen atoms is 0.01 to 10 mass %.
[20] The resin composition according to any one of [1] to [19], in which, based on the solid content of the resin composition, a content of the resin is 1 to 80 mass %, a content of the organophosphorus compound is 0.1 to 30 mass %, and a content of the compound having at least one atom selected from the group consisting of an oxygen atom and a nitrogen atom is 1 to 80 mass %.
[21] A prepreg containing the resin composition according to any one of [1] to [20].
[22] A metal-clad laminate including a cured product of the resin composition according to any one of [1] to [20] and a metal foil.
[23] A method for producing a metal-clad laminate, the method including laminating a prepreg containing the resin composition according to any one of [1] to [20] and a metal foil.

According to the present disclosure, there are provided a resin composition with excellent electrical properties and flame retardancy, a prepreg, a metal-clad laminate, and a method for producing the same.

The above and other objects, features and advantages of the present disclosure will become more fully understood from the detailed description given hereinbelow.

### DESCRIPTION OF EMBODIMENTS

In the present specification, numerical ranges expressed using “to” include the numerical values described before and after “to” as the minimum value and the maximum value, respectively.

In numerical ranges described stepwise in the present specification, an upper limit value or a lower limit value described in one numerical range may be replaced with an upper limit value or a lower limit value of another stepwise-described numerical range. In addition, in numerical ranges described in the present specification, an upper limit value or a lower limit value of the numerical range may be replaced with a value shown in the Examples.

When the same symbol is present in a single chemical formula, the same symbol may represent structures that are identical to each other, or may represent structures that are different from each other within the defined range.

As described above, a composition (resin composition) used for a laminate mounted on electrical and electronic components is required to have various practical performance properties, including electrical properties.

In particular, for laminates used in high-speed communication, it is desirable to use a resin having an extremely low loss, with a dielectric loss tangent at a frequency of 10 GHz of 0.004 or less (more preferably 0.0015 or less).

As such resins, a hydrocarbon-based resin composed of carbon atoms and hydrogen atoms, and a fluororesin have heretofore been used. More specifically, examples of the hydrocarbon-based resin include a polyfunctional vinyl aromatic polymer, a cyclic polyolefin resin, and a vinyl aromatic compound-conjugated diene-based compound copolymer. In addition, examples of the fluororesin include polytetrafluoroethylene.

Japanese Unexamined Patent Application Publication No. 2022-100270 discloses, as a resin having sufficient electrical properties, a polymer based on a specific diisoalkenyl arene, which is understood to have a large amount of an indane structure described below.

However, when the polymer described in Japanese Unexamined Patent Application Publication No. 2022-100270 is used for a laminate, it has sometimes been difficult to achieve both electrical properties and flame retardancy. The present inventors have found that, by using a resin composition containing a resin having an α-olefin structure represented by the following Formula (1), an organophosphorus compound, and a compound having at least one atom selected from the group consisting of an oxygen atom and a nitrogen atom, for a metal-clad laminate, excellent electrical properties and flame retardancy can be imparted.

In recent years, in order to address environmental issues related to the manufacture and disposal of printed wiring boards using metal-clad laminates, there has been a demand for metal-clad laminates using a halogen-free resin composition that does not contain a halogen material. The resin composition according to the present disclosure can also be a halogen-free resin composition that can easily achieve both electrical properties and flame retardancy without using a halogen material.

Hereinafter, embodiments of a resin composition according to the present disclosure (hereinafter, also referred to as “the present composition”) will be described in detail; however, the present disclosure is not limited to these embodiments. In addition, the present disclosure can be carried out with arbitrary modifications within a range not departing from the gist of the present disclosure.

### <Resin Composition>

The present composition contains at least a resin having an α-olefin structure represented by Formula (1) (hereinafter, also referred to as a resin A), an organophosphorus compound (hereinafter, also referred to as a compound B), and a compound having at least one atom selected from the group consisting of an oxygen atom and a nitrogen atom (hereinafter, also referred to as a compound C). By using these resins and compounds in combination, the present composition can suppress a dielectric loss tangent Df to a low level and can further impart excellent flame retardancy. The molecular structures of the resins and compounds contained in the composition can be identified using ¹H-NMR. ¹³C-NMR, and the like. Details will be described below. Hereinafter, each component contained in the present composition will be described in detail.

(Resin having α-olefin structure represented by Formula (1))

The resin A has, as a unit structure, an α-olefin structure represented by the following Formula (1), at least. By containing the resin A, the present composition can impart excellent electrical properties and can further improve heat resistance and adhesion to a metal foil. The resin A may be used alone, or two or more kinds thereof may be used in combination. In addition, the resin A may be a curable resin.

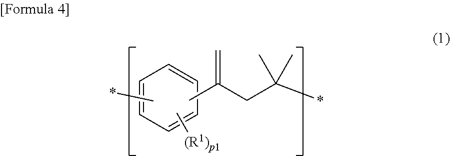

Here, in Formula (1), each R¹ independently represents a C1-C10 hydrocarbon group or a halogenated alkyl group, p1 represents an integer of 0 to 4, and each * represents a bonding position.

In Formula (1), R¹ is a C1-C10 hydrocarbon group or a halogenated alkyl group, and from the viewpoints of imparting excellent electrical properties and achieving a halogen-free composition, R¹ is preferably a C1-C5 hydrocarbon group, and more preferably a C1-C3 hydrocarbon group. Examples of the hydrocarbon group include a methyl group, an ethyl group, an n-propyl group, an isopropyl group, an isopropenyl group, a t-butyl group, and an n-butyl group. The halogenated alkyl group is a group in which a hydrogen atom of an alkyl group is substituted with a halogen atom, and examples of the halogen atom include F, Cl, Br, and I. The number of carbon atoms of the alkyl group is, for example, 1 to 10.

In Formula (1), p1 is an integer of 0 to 4, preferably 0 to 3, and more preferably 0.

The resin A, details of which will be described below, can be a resin obtained by polymerizing a compound having a plurality of isopropenyl groups (for example, a diisopropenyl compound) at a specific reaction temperature in the presence of an acid catalyst. Examples of the compound having a plurality of isopropenyl groups include 1,3-diisopropenylbenzene and 1,4-diisopropenylbenzene. These diisopropenyl compounds produced by known methods can be used. For example, a diisopropenyl compound can be synthesized by intramolecular dehydration of a diol compound obtained by oxidizing a cumyl group and subjecting the oxidized product to hydrogenation. Further, a diisopropenyl compound can also be produced by adding propylene to an aromatic compound and performing a dehydrogenation reaction.

The raw material monomer for producing the resin A may also be a precursor of a compound having a plurality of isopropenyl groups (for example, a diisopropenyl compound precursor).

From the viewpoints of flexibility, adhesion to a metal foil, and curability, the iodine value of the resin A is preferably, for example, the following value. That is, the iodine value of the resin A is preferably, for example, 70 or more, 71 or more, 72 or more, 73 or more, 74 or more, 75 or more, 76 or more, 77 or more, 78 or more, 79 or more, 80 or more, 81 or more, 82 or more, 83 or more, 84 or more, 85 or more, 86 or more, 87 or more, 88 or more, 89 or more, 90 or more, 91 or more, 92 or more, 93 or more, more than 93, 94 or more, or 95 or more.

In addition, from the viewpoints of controllability of the degree of polymerization, heat resistance, and curability, the iodine value of the resin A is preferably, for example, the following value. That is, the iodine value of the resin A is preferably, for example, 200 or less, 195 or less, 190 or less, 185 or less, 180 or less, 175 or less, 170 or less, 165 or less, 160 or less, 155 or less, or 150 or less.

Here, the iodine value refers to the number of grams of iodine (I₂) that can be added to (react with) 100 grains of a target sample (here, the resin A). Accordingly, a larger value indicates a higher degree of unsaturation in the sample, that is, a larger number of unsaturated bonds (double bonds) in the structure. Since the α-olefin structure has a double bond in the structure, the iodine value can serve as one indicator for determining the content ratio of the α-olefin structure in the resin A. The iodine value can be determined by the Wijs method.

From the viewpoints of curability and heat resistance, the weight average molecular weight Mw of the resin A is preferably, for example, the following value. That is, the weight average molecular weight Mw of the resin A is preferably, for example, 2,500 or more, 2,550 or more, 2,600 or more, 2,650 or more, 2,700 or more, 2,750 or more, 2,800 or more, 2,850 or more, 2,900 or more, 2,950 or more, 3,000 or more, 3,100 or more, 3,200 or more, 3,300 or more, 3,400 or more, 3,500 or more, 3,600 or more, 3,700 or more, 3,800 or more, 3,900 or more, 4,000 or more, 4,100 or more, 4,200 or more, 4,300 or more, 4,400 or more, 4,500 or more, 4,600 or more, 4,700 or more, 4,800 or more, 4,900 or more, 5,000 or more, 5,100 or more, 5,200 or more, 5,300 or more, 5,400 or more, 5,500 or more, 5,600 or more, 5,700 or more, 5,800 or more, 5,900 or more, 6,000 or more, more than 6,000, 6,100 or more, 6,200 or more, 6,300 or more, 6,400 or more, 6,500 or more, 6,600 or more, 6,700 or more, 6,800 or more, 6,900 or more, 7,000 or more, 7,500 or more, 8,000 or more, 8,500 or more, 9,000 or more, 9,500 or more, or 10,000 or more. In addition, from the viewpoint of solvent solubility, the weight average molecular weight Mw of the resin A is preferably, for example, the following value. That is, the weight average molecular weight Mw of the resin A is preferably, for example, 500,000 or less, 450,000 or less, 400,000 or less, 350,000 or less, 300,000 or less, 250,000 or less, 200,000 or less, 190,000 or less, 180,000 or less, 170,000 or less, 160,000 or less, 150,000 or less, 140,000 or less, 130,000 or less, 120,000 or less, 110,000 or less, or 100,000 or less. The method for measuring the weight average molecular weight will be described below.

The number average molecular weight Mn of the resin A is preferably 700 or more, and more preferably 1,000 or more. In addition, the number average molecular weight Mn of the resin A is preferably 5,000 or less. The method for measuring the number average molecular weight will be described below.

From the viewpoints of electrical properties, heat resistance, and adhesion to a metal foil, a content of an α-olefin structure represented by Formula (1) in the resin A (hereinafter, also referred to as an α-olefin content) is preferably, for example, the following value. That is, the α-olefin content (content ratio) is preferably, for example, 1.0 mmol/g or more, 1.1 mmol/g or more, 1.2 mmol/g or more, 1.3 mmol/g or more, 1.4 mmol/g or more, 1.5 mmol/g or more, 1.6 mmol/g or more, 1.7 mmol/g or more, 1.8 mmol/g or more, 1.9 mmol/g or more, 2.0 mmol/g or more, 2.1 mmol/g or more, 2.2 mmol/g or more, 2.3 mmol/g or more, or 2.35 mmol/g or more.

In addition, from the viewpoints of heat resistance and curability, a content of the α-olefin structure in the resin A is preferably, for example, the following value. That is, the α-olefin content is preferably, for example, 6.3 mmol/g or less, 6.2 mmol/g or less, 6.1 mmol/g or less, 6.0 mmol/g or less, 5.9 mmol/g or less, 5.8 mmol/g or less, 5.7 mmol/g or less, 5.6 mmol/g or less, 5.5 mmol/g or less, 5.4 mmol/g or less, 5.3 mmol/g or less, 5.2 mmol/g or less, 5.1 mmol/g or less, or 5.0 mmol/g or less.

From the viewpoint of electrical properties, the resin A preferably has a content of heteroatoms other than carbon atoms and hydrogen atoms of 3 mass % or less, and more preferably contains no such heteroatoms. The content of heteroatoms in the resin A can be determined by, for example, elemental analysis by a combustion method.

As described above, the resin A. details of which will be described below, can be a polymer of a diisopropenyl compound. As unit structures, the resin A may have, in addition to the α-olefin structure represented by the above Formula (1), an olefin structure located at a molecular terminal (terminal olefin structure), a side-chain olefin structure having an olefin structure in a side-chain portion, an indane structure represented by Formula (2) described below, an inner olefin structure represented by Formula (3) described below, and other structures.

In addition to the (α-olefin structure, the resin A preferably has one or both of the terminal olefin structure and the side-chain olefin structure. By having these terminal olefin structures and side-chain olefin structures, the resin A can improve adhesion to a metal foil and can impart high metal peel strength (peel strength).

More specifically, a total content of the α-olefin structure, an olefin structure located at a molecular terminal (terminal olefin structure), and a side-chain olefin structure having an olefin structure in a side-chain portion in the resin A is preferably as follows. That is, from the viewpoint of peel strength, a total content of these three structures (hereinafter, also referred to as a three-structure content) is preferably, for example, the following value. That is, the three-structure content is preferably, for example, 1.8 mmol/g or more, 1.9 mmol/g or more, 2.0 mmol/g or more, 2.1 mmol/g or more, 2.2 mmol/g or more, or 2.3 mmol/g or more.

In addition, from the viewpoints of heat resistance and curability, the total content of these three structures in the resin A is preferably, for example, the following value. That is, the three-structure content is preferably, for example, 6.5 mmol/g or less, 6.4 mmol/g or less, 6.3 mmol/g or less, 6.2 mmol/g or less, 6.1 mmol/g or less, 6.0 mmol/g or less, 5.9 mmol/g or less, 5.8 mmol/g or less, 5.7 mmol/g or less, 5.6 mmol/g or less, 5.5 mmol/g or less, 5.4 mmol/g or less, 5.3 mmol/g or less, 5.2 mmol/g or less, 5.1 mmol/g or less, or 5.0 mmol/g or less.

Further, from the viewpoint of peel strength, a total content of the terminal olefin structure and the side-chain olefin structure in the resin A (hereinafter, also referred to as a two-structure content) is preferably, for example, the following value. That is, the two-structure content is preferably, for example, 0.1 mmol/g or more, 0.11 mmol/g or more, 0.12 mmol/g or more, 0.13 mmol/g or more, 0.14 mmol/g or more, 0.15 mmol/g or more, 0.16 mmol/g or more, 0.17 mmol/g or more, 0.18 mmol/g or more, 0.19 mmol/g or more, 0.2 mmol/g or more, 0.25 mmol/g or more, or 0.3 mmol/g or more.

In addition, from the viewpoints of heat resistance and curability, the total content of the terminal olefin structure and the side-chain olefin structure in the resin A is preferably, for example, the following value. That is, the two-structure content is preferably, for example, 6.0 mmol/g or less, 5.9 mmol/g or less, 5.8 mmol/g or less, 5.7 mmol/g or less, 5.6 mmol/g or less, 5.5 mmol/g or less, 5.4 mmol/g or less, 5.3 mmol/g or less, 5.2 mmol/g or less, 5.1 mmol/g or less, 5.0 mmol/g or less, 4.9 mmol/g or less, 4.8 mmol/g or less, 4.7 mmol/g or less, 4.6 mmol/g or less, 4.5 mmol/g or less, 4.4 mmol/g or less, 4.3 mmol/g or less, 4.2 mmol/g or less, 4.1 mmol/g or less, or 4.0 mmol/g or less.

The total content of these three structures in the resin A may be constituted by two of the three structures, or may be constituted by one structure (for example, the α-olefin structure). That is, the resin A may have only one of the above three structures (for example, the α-olefin structure), may have only two of the structures, or may have all three of the structures.

From the above, the resin A may be a polymer having, as repeating units, an α-olefin structure, a terminal olefin structure, and a side-chain olefin structure, and, as necessary, an indane structure, an inner olefin structure, and other structures.

The terminal olefin structure described above refers to an olefin structure located at a molecular terminal, and although the structure is not particularly limited, it can be represented, for example, by the following Formula (4).

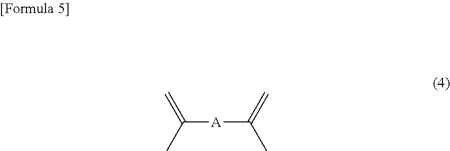

Here, in Formula (4), A represents a polymer chain, and may have at least one structure selected from the group consisting of an α-olefin structure represented by Formula (1), a side-chain olefin structure represented by the following Formula (5), an indane structure represented by the following Formula (2), and an inner olefin structure represented by the following Formula (3). In 5 the present embodiment, A has at least the α-olefin structure represented by Formula (1).

In addition, the terminal olefin structure may be a structure represented by the following Formula (4-1).

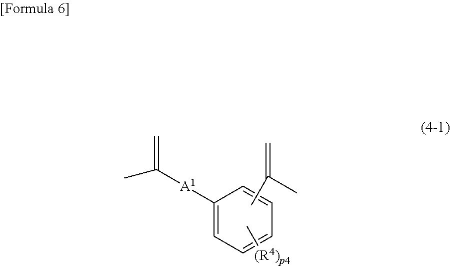

Here, in Formula (4-1), A¹ represents a polymer chain, and may have at least one structure selected from the group consisting of an α-olefin structure represented by Formula (1), a side-chain olefin structure represented by the following Formula (5), an indane structure represented by the following Formula (2), and an inner olefin structure represented by the following Formula (3). In the present embodiment, A has at least the α-olefin structure represented by Formula (1). In addition, in Formula (4-1), each R⁴ independently represents a C1-C10 hydrocarbon group or a halogenated alkyl group, and p4 represents an integer of 0 to 4.

In Formula (4-1), R⁴ is a C1-C10 hydrocarbon group or a halogenated alkyl group, and from the viewpoints of electrical properties and halogen-free characteristics, R⁴ is preferably a C1-C5 hydrocarbon group, and more preferably a C1-C3 hydrocarbon group. Examples of the hydrocarbon group include a methyl group, an ethyl group, an n-propyl group, an isopropyl group, an isopropenyl group, a t-butyl group, and an n-butyl group. The halogenated alkyl group is a group in which a hydrogen atom of an alkyl group is substituted with a halogen atom, and examples of the halogen atom include F, Cl, Br, and I. The number of carbon atoms of the alkyl group is, for example, 1 to 10.

In addition, in Formula (4-1), p4 is an integer of 0 to 4, preferably 0 to 3, and more preferably 0.

The side-chain olefin structure described above only needs to have an olefin structure in a side-chain portion, and although the structure is not particularly limited, the side-chain olefin structure can be, for example, a structure represented by the following Formula (5).

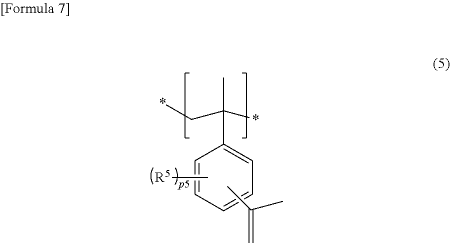

Here, in Formula (5), each R⁵ independently represents a C1-C10 hydrocarbon group or a halogenated alkyl group, p5 represents an integer of 0 to 4, and each * represents a bonding position.

In Formula (5), R⁵ is a C1-C10 hydrocarbon group or a halogenated alkyl group, and from the viewpoints of electrical properties and halogen-free characteristics, R⁵ is preferably a C1-C5 hydrocarbon group, and more preferably a C1-C3 hydrocarbon group. Examples of the hydrocarbon group include a methyl group, an ethyl group, an n-propyl group, an isopropyl group, an isopropenyl group, a t-butyl group, and an n-butyl group. The halogenated alkyl group is a group in which a hydrogen atom of an alkyl group is substituted with a halogen atom, and examples of the halogen atom include F, Cl, Br, and I. The number of carbon atoms of the alkyl group is, for example, 1 to 10.

In addition, in Formula (5), p5 is an integer of 0 to 4, preferably 0 to 3, and more preferably 0.

The indane structure described above is represented by the following Formula (2).

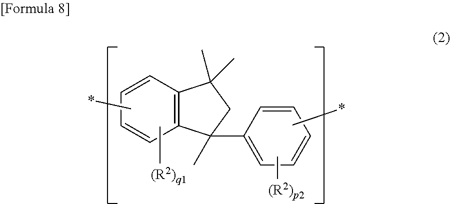

Here, in Formula (2), each R² independently represents a C1-C10 hydrocarbon group or a halogenated alkyl group, p2 represents an integer of 0 to 4, q1 represents an integer of 0 to 3, and each * represents a bonding position.

In Formula (2), R² is a C1-C10 hydrocarbon group or a halogenated alkyl group, and from the viewpoints of electrical properties and halogen-free characteristics, R² is preferably a C1-C5 hydrocarbon group, and more preferably a C1-C3 hydrocarbon group. Examples of the hydrocarbon group include a methyl group, an ethyl group, an n-propyl group, an isopropyl group, an isopropenyl group, a t-butyl group, and an n-butyl group. The halogenated alkyl group is a group in which a hydrogen atom of an alkyl group is substituted with a halogen atom, and examples of the halogen atom include F, Cl, Br, and I. The number of carbon atoms of the alkyl group is, for example, 1 to 10.

In addition, in Formula (2), p2 is an integer of 0 to 4, preferably 0 to 3, and more preferably 0.

Further, q1 is an integer of 0 to 3, preferably 0 to 2, and more preferably 0.

The inner olefin structure described above is represented by the following Formula (3).

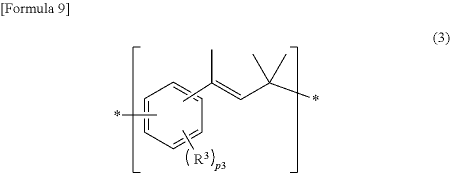

Here, in Formula (3), each R³ independently represents a C1-C10 hydrocarbon group or a halogenated alkyl group, p3 represents an integer of 0 to 4, and each * represents a bonding position.

In Formula (3), R³ is a C1-C10 hydrocarbon group or a halogenated alkyl group, and from the viewpoints of electrical properties and halogen-free characteristics, R³ is preferably a C1-C5 hydrocarbon group, and more preferably a C1-C3 hydrocarbon group. Examples of the hydrocarbon group include a methyl group, an ethyl group, an n-propyl group, an isopropyl group, an isopropenyl group, a t-butyl group, and an n-butyl group. The halogenated alkyl group is a group in which a hydrogen atom of an alkyl group is substituted with a halogen atom, and examples of the halogen atom include F, Cl, Br, and I. The number of carbon atoms of the alkyl group is, for example, 1 to 10.

In addition, in Formula (3), p3 is an integer of 0 to 4, preferably 0 to 3, and more preferably 0.

Here, since the indane structure has an excellent balance between aromaticity and aliphaticity, the indane structure improves solvent solubility and compatibility with other polymers, and imparts excellent heat resistance. However, when a content ratio of the indane structure in the resin A is high, adhesion to a metal foil tends to decrease; therefore, a content of the indane structure in the resin A (hereinafter, also referred to as an indane content) is preferably smaller than that of the α-olefin structure. The content of the indane structure in the resin A is preferably, for example, as follows. That is, the content of the indane structure in the resin A is preferably, for example, 4.2 mmol/g or less, 4.1 mmol/g or less, 4.0 mmol/g or less, 3.9 mmol/g or less, 3.8 mmol/g or less, 3.7 mmol/g or less, 3.6 mmol/g or less, 3.5 mmol/g or less, 3.4 mmol/g or less, 3.3 mmol/g or less, 3.2 mmol/g or less, 3.1 mmol/g or less, 3.0 mmol/g or less, 2.9 mmol/g or less, 2.8 mmol/g or less, 2.7 mmol/g or less, 2.6 mmol/g or less, 2.5 mmol/g or less, 2.4 mmol/g or less, 2.3 mmol/g or less, 2.2 mmol/g or less, 2.1 mmol/g or less, 2.0 mmol/g or less, 1.9 mmol/g or less, 1.8 mmol/g or less, 1.7 mmol/g or less, 1.6 mmol/g or less, or 1.5 mmol/g or less. In addition, from the viewpoint of ease of production, the content of the indane structure in the resin A is preferably, for example, as follows. That is, the indane content in the resin A is preferably, for example, 0.01 mmol/g or more, 0.02 mmol/g or more, 0.03 mmol/g or more, 0.04 mmol/g or more, or 0.05 mmol/g or more.

For example, in a case where the resin A (diisopropenyl compound homopolymer) is produced using a diisopropenyl compound as a raw material monomer, when the iodine value described above exhibits a small value, it is considered that the content ratio of the indane structure is high.

The inner olefin structure improves electrical properties and heat resistance and imparts favorable curability; however, with respect to contribution to curability, the α-olefin structure is excellent. Accordingly, the content of the α-olefin structure in the resin A (α-olefin content) is preferably higher than the content of the inner olefin structure (hereinafter, also referred to as an inner olefin content).

In addition, in the resin A, the following parameter FA, defined by the content of the α-olefin structure, the content of the inner olefin structure, and the content of the indane structure described above, is preferably 0.39 or more.

FA=[content of α-olefin structure]/([content of inner olefin structure]+[content of indane structure]+[content of α-olefin structure])

Here, when the FA is 0.39 or more, a resin with excellent adhesion to a metal foil and excellent electrical properties and heat resistance can be easily produced. In addition, from the same viewpoint, the FA is preferably, for example, 0.40 or more, 0.41 or more, 0.42 or more, 0.43 or more, 0.44 or more, 0.45 or more, 0.46 or more, 0.47 or more, 0.48 or more, 0.49 or more, 0.50 or more, 0.51 or more, 0.52 or more, 0.53 or more, 0.54 or more, 0.55 or more, 0.56 or more, 0.57 or more, 0.58 or more, 0.59 or more, 0.60 or more, 0.61 or more, 0.62 or more, 0.63 or more, 0.64 or more, 0.65 or more, 0.66 or more, 0.67 or more, 0.68 or more, 0.69 or more, 0.70 or more, 0.71 or more, 0.72 or more, 0.73 or more, 0.74 or more, or 0.75 or more. In addition, from the same viewpoint, the FA is preferably, for example, 0.95 or less.

Further, in the resin A, the following parameter FI, defined by the content of the α-olefin structure, the content of the inner olefin structure, and the content of the indane structure described above, is preferably less than 0.58.

FI=[content of indane structure]/([content of inner olefin structure]+[content of indane structure]+[content of α-olefin structure]/2)

Here, when the above FI is less than 0.58, a resin with excellent adhesion to a metal foil can be easily produced. In addition, from the same viewpoint, the F1 is, for example, 0.579 or less, 0.575 or less, 0.57 or less, 0.56 or less, 0.55 or less, 0.54 or less, 0.53 or less, 0.52 or less, 0.51 or less, 0.50 or less, 0.49 or less, 0.48 or less, 0.47 or less, 0.46 or less, 0.45 or less, 0.44 or less, 0.43 or less, 0.42 or less, 0.41 or less, 0.40 or less, 0.39 or less, 0.38 or less, 0.37 or less, 0.36 or less, 0.35 or less, 0.34 or less, 0.33 or less, 0.32 or less, 0.31 or less, 0.30 or less, 0.29 or less, 0.28 or less, 0.27 or less, 0.26 or less, or 0.25 or less. In addition, from the same viewpoint, the F1 is preferably, for example, 0.15 or more.

Here, since a preferred form as a resin varnish can be maintained, when the resin A is dissolved in a solvent at a concentration of 60 mass %, a mixing ratio of insoluble components is preferably 5 mass % or less, more preferably 4 mass % or less, and still more preferably 3 mass % or less. Examples of the solvent include methyl ethyl ketone and toluene.

From the viewpoint of practical application, the dielectric loss tangent of the resin A at a frequency of 10 GH-z is preferably 0.004 or less, more preferably 0.0015 or less, still more preferably 0.001 or less, and particularly preferably 0.0008 or less. The method for measuring the dielectric loss tangent will be described below.

In the present specification, the glass transition temperature (Tg) (of a cured product) refers to the glass transition temperature of a cured product obtained by curing the resin A according to the present disclosure or the resin composition according to the present disclosure. The cured product exhibits an excellent glass transition temperature and can exhibit preferred heat resistance. The glass transition temperature of the cured product is preferably 125° C. or higher, more preferably 150° C. or higher, still more preferably 175° C. or higher, and particularly preferably 200° C. or higher. The method for measuring the glass transition temperature will be described below.

The resin A exhibits the above-described glass transition temperature even when thermally cured at a thermosetting temperature used in producing a substrate material such as a prepreg. The thermosetting temperature is at most 250° C., for example, 150 to 230° C.

In addition, the cured product exhibiting the heat resistance may be a cured product obtained by curing the resin composition according to the present disclosure, as described above.

The resin A may be composed of one kind of polymer, or may be composed of a plurality of polymers. When the resin A is composed of a plurality of polymers, various physical properties described above, such as a content ratio of insoluble components with respect to a solvent, the glass transition temperature, and the dielectric loss tangent, are values for a mixture (resin) of the plurality of polymers.

From the viewpoints of electrical properties, heat resistance, and adhesion to a metal foil, a content ratio of the resin A in the solid content of the present composition is preferably 1 mass % or more, more preferably 5 mass % or more, and still more preferably 10 mass % or more. In addition, from the viewpoint of flame retardancy, the content ratio of the resin A in the solid content of the present composition is preferably 80 mass % or less, more preferably 70 mass % or less, still more preferably 50 mass % or less, even more preferably 40 mass % or less, and particularly preferably 30 mass % or less.

### (Organophosphorus Compound)

The organophosphorus compound (compound B) is not particularly limited as long as it is an organic compound containing carbon atoms and phosphorus atoms (for example, as carbon-phosphorus bonds), and conventionally known compounds can be appropriately used. The organophosphorus compound can act as a flame retardant. The organophosphorus compound may be used alone, or two or more kinds thereof may be used in combination.

From the viewpoint of improving flame retardancy, the organophosphorus compound preferably has a solubility in toluene at 25° C. of 5 g or less per 100 g of toluene, more preferably 4 g or less, and still more preferably 3 g or less. In other words, from the viewpoints of heat resistance and chemical resistance, the organophosphorus compound is preferably incompatible with toluene.

In addition, from the viewpoints of heat resistance and chemical resistance, the organophosphorus compound is preferably incompatible also with the above-described resin A.

Further, from the viewpoint of heat resistance, the melting point of the organophosphorus compound is preferably 240° C. or higher, more preferably 250° C. or higher, and still more preferably 260° C. or higher. When the melting point of the organophosphorus compound is 240° C. or higher, a change in volume at a high temperature can be easily suppressed, and favorable effects such as improvement in reliability when formed into a printed wiring board and reduction in warpage of a substrate are readily obtained.

From the viewpoint of improving flame retardancy, the organophosphorus compound is preferably a pentavalent organophosphorus compound having a P═O bond in the molecular structure. Examples of the pentavalent organophosphorus compound include an organophosphorus compound having a phosphine oxide structure represented by the following Formula (6), an organophosphorus compound having a phosphinic acid structure represented by the following Formula (7), an organophosphorus compound having a phosphonic acid structure represented by the following Formula (8), and an organophosphorus compound having a phosphoric acid structure represented by the following Formula (9). Among these, from the viewpoint of electrical properties, the organophosphorus compound used in the present composition preferably has a phosphine oxide structure, a phosphinic acid structure, or a phosphoric acid structure, and more preferably has a phosphine oxide structure or a phosphinic acid structure. Compounds in which a plurality of organophosphorus compounds are coordinated via a metal (for example, Al, Mg, or Ca) can also be used as the compound B. Further, these organophosphorus compounds may form dimers as shown in the following Formulas (10) and (11), or may form trimers.

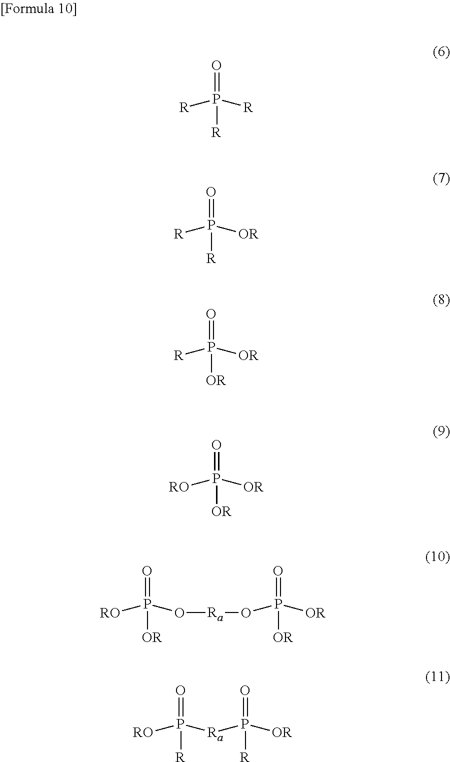

In Formulas (6) to (11), each R independently represents a substituted or unsubstituted hydrocarbon group, and R groups may be bonded to each other to form a ring structure. In Formulas (10) and (11), each Ra independently represents a substituted or unsubstituted divalent hydrocarbon group. The plurality of R may be the same as or different from each other.

Examples of the hydrocarbon group represented by R include a saturated hydrocarbon group, an unsaturated hydrocarbon group, and an aromatic hydrocarbon group, and a group obtained by combining these groups may also be used.

The saturated hydrocarbon group may be linear, branched, or cyclic, and examples thereof include an alkyl group. The number of carbon atoms in the saturated hydrocarbon group is preferably 1 to 20.

The unsaturated hydrocarbon group may be linear, branched, or cyclic, and examples thereof include an alkenyl group. The number of carbon atoms in the unsaturated hydrocarbon group is preferably 1 to 20.

The aromatic hydrocarbon group preferably has 5 to 20 carbon atoms, and examples thereof include aryl groups such as a phenyl group and a monovalent biphenyl group.

These hydrocarbon groups may contain heteroatoms (for example, an oxygen atom or a nitrogen atom) in the structure.

In addition, these hydrocarbon groups may have or may not have a substituent, and the number of the substituents is not particularly limited. Examples of the substituent include an alkyl group, a halogen group, and an alkoxy group. However, from the viewpoint of environmental issues, the substituent is preferably an alkyl group or an alkoxy group.

Examples of the divalent hydrocarbon group represented by Ra include a divalent saturated hydrocarbon group, a divalent unsaturated hydrocarbon group, and a divalent aromatic hydrocarbon group, and a group obtained by combining these groups may also be used.

The divalent saturated hydrocarbon group may be linear, branched, or cyclic, and examples thereof include an alkylene group. The number of carbon atoms in the divalent saturated hydrocarbon group is preferably 1 to 20.

The divalent aromatic hydrocarbon group preferably has 5 to 20 carbon atoms, and examples thereof include a phenylene group and a divalent biphenyl group (—C₆H₅—C₆H₅—).

The divalent unsaturated hydrocarbon group preferably has 2 to 20 carbon atoms, and examples thereof include an alkenylene group and an alkynylene group.

These divalent hydrocarbon groups may contain heteroatoms (for example, an oxygen atom or a nitrogen atom) in the structure.

Examples of the substituents of these divalent hydrocarbon groups include an alkyl group, a halogen group, an alkoxy group, and a heterocyclic group. However, from the viewpoint of environmental issues, the substituent is preferably an alkyl group, an alkoxy group, or a heterocyclic group. Examples of the heterocycle in the heterocyclic group include a furan ring, a thiophene ring, a pyrrole ring, an imidazole ring, a pyridine ring, a pyrimidine ring, a pyrazine ring, and a triazine ring.

As the organophosphorus compounds contained in the present composition, for example, the following compounds can be used. These compounds can be produced by conventionally known methods. As the organophosphorus compound, a commercially available product may be used. The following compounds P-1 to P-15 are as follows.
Compound P-1: aluminum tris(diethylphosphinate)
Compound P-2: diphenyl vinyl phosphine oxide
Compound P-3: compound described in Japanese Patent No. 6,635,415
Compound P-4: compounds described in International Patent Publication Nos. WO 2020-031495 and WO 2022-259851
Compound P-5: compound described in U.S. Pat. No. 10,626,250
Compound P-6: compound described in Japanese Patent No. 3,897,138
Compound P-7: compound described in Chinese Unexamined Patent Application Publication No. 115,710,424
Compound P-8: MC-4 (trade name, manufactured by KATAYAMA CHEMICAL INDUSTRIES Co., Ltd.)
Compound P-9: compound described in Japanese Patent No. 6,635,415
Compound P-10: S-4 (trade name, manufactured by KATAYAMA CHEMICAL INDUSTRIES Co., Ltd.)
Compound P-11: compound described in Japanese Patent No. 6,757,215
Compound P-12: PX-200 (trade name, manufactured by DAIHACHI CHEMICAL INDUSTRY CO., LTD.)
Compound P-13: SPV-100 (trade name, manufactured by Otsuka Chemical Co., Ltd.)
Compound P-14: SPB-100 (trade name, manufactured by Otsuka Chemical Co., Ltd.)
Compound P-15: FP-700TP (trade name, manufactured by FUSHIMI Pharmaceutical Co., Ltd.)

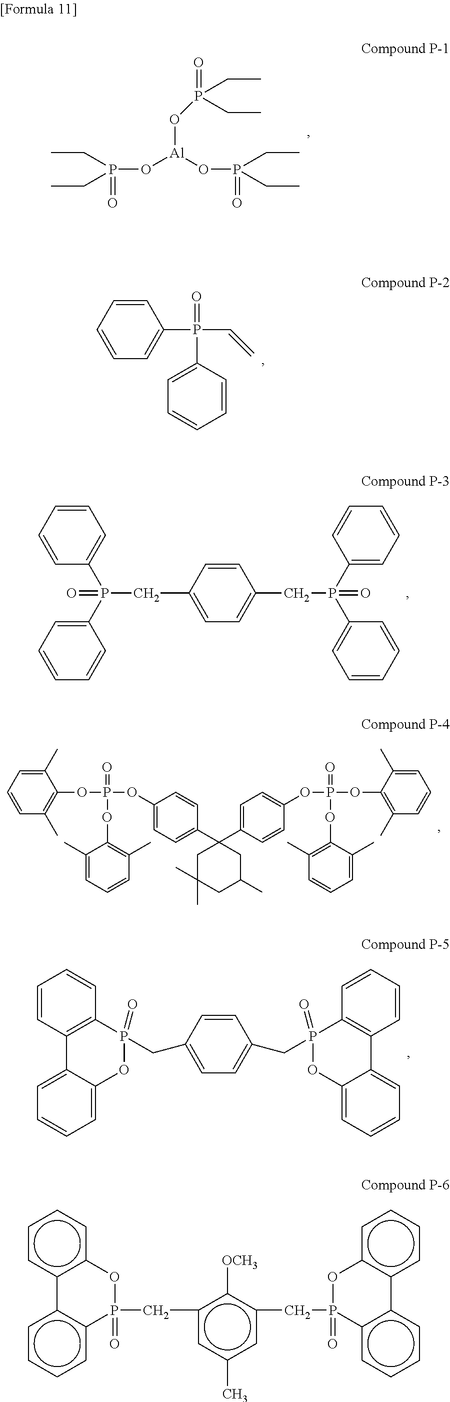

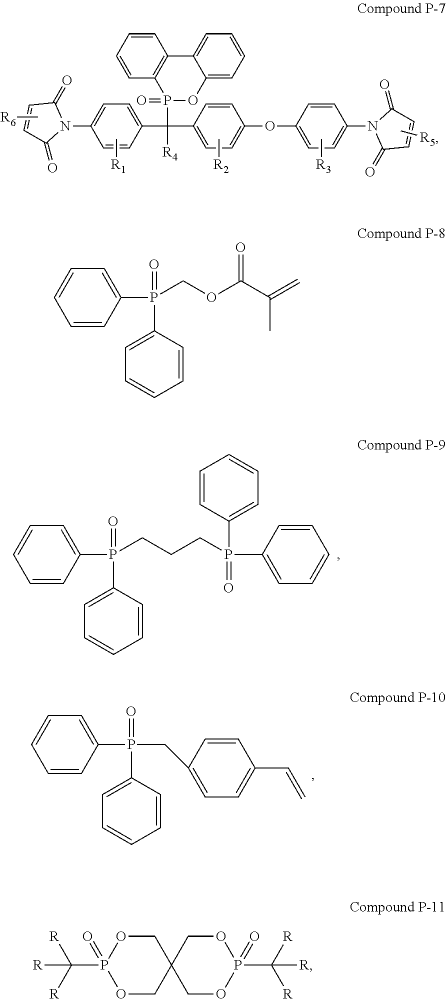

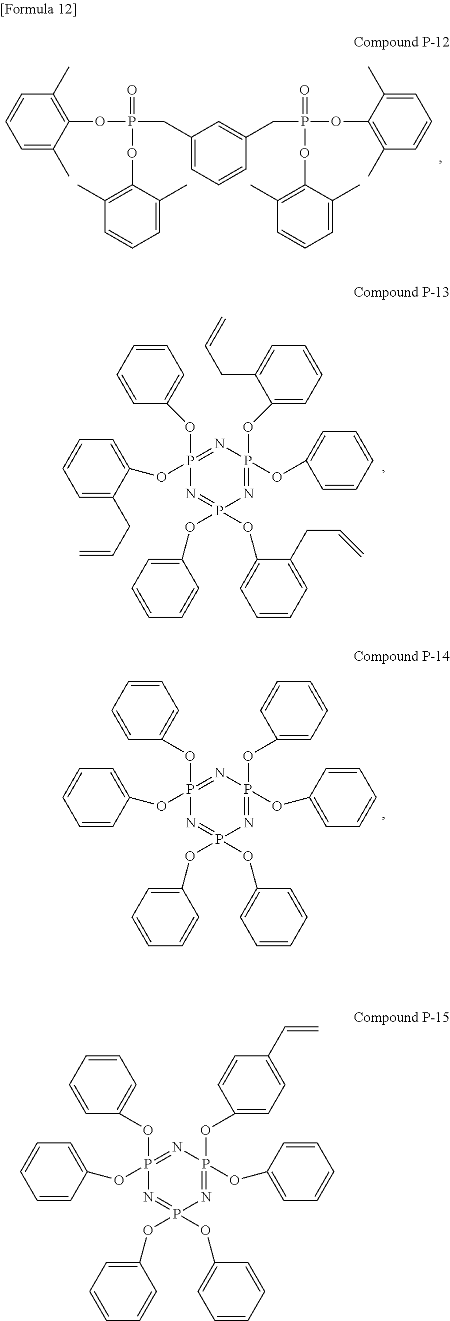 [SMILES: Cc1cccc(C)c1OP(=O)(Cc1cccc(CP(=O)(Oc2c(C)cccc2C)Oc2c(C)cccc2C)c1)Oc1c(C)cccc1C ; C=CCc1ccccc1OP1(Oc2ccccc2)=NP(Oc2ccccc2)(Oc2ccccc2CC=C)=NP(Oc2ccccc2)(Oc2ccccc2CC=C)=N1 ; c1ccc(OP2(Oc3ccccc3)=NP(Oc3ccccc3)(Oc3ccccc3)=NP(Oc3ccccc3)(Oc3ccccc3)=N2)cc1 ; C=Cc1ccc(OP2(Oc3ccccc3)=NP(Oc3ccccc3)(Oc3ccccc3)=NP(Oc3ccccc3)(Oc3ccccc3)=N2)cc1]

From the viewpoint of flame retardancy, a content ratio of the organophosphorus compound in the solid content of the present composition is preferably 0.1 mass % or more, more preferably 1 mass % or more, and still more preferably 10 mass % or more. In addition, from the viewpoint of electrical properties, the content ratio of the organophosphorus compound in the solid content of the present composition is preferably 30 mass % or less, more preferably 25 mass % or less, and still more preferably 20 mass % or less.

(Compound Having at Least One Atom Selected from the Group Consisting of Oxygen Atom and Nitrogen Atom)

The compound C only needs to contain at least one atom selected from the group consisting of an oxygen atom and a nitrogen atom, and the structure thereof is not particularly limited. The compound C may be, for example, a polymer or an elastomer. Compounds corresponding to the resin A and the organophosphorus compound (compound B) described above are not included in the compound C. In addition, the compound C may be used alone, or two or more kinds thereof may be used in combination.

From the viewpoint of heat resistance, the number average molecular weight Mn of the compound C is preferably 300 or more, more preferably 500 or more, and still more preferably 1,000 or more. In addition, from the viewpoint of resin flowability, the number average molecular weight Mn of the compound C is preferably 50,000 or less, more preferably 35,000 or less, and still more preferably 20,000 or less.

The weight average molecular weight Mw of the compound C is preferably 1,000 or more from the viewpoints of electrical properties, heat resistance, polymerizability, and the like. In addition, the weight average molecular weight Mw of the compound C is preferably 500,000 or less, more preferably 100,000 or less, still more preferably 50,000 or less, and particularly preferably 10,000 or less, from the viewpoint of solubility in solvents.

The compound C preferably has a radical-polymerizable group in the molecular structure. The radical-polymerizable group may be any group that enables radical polymerization, and may be a group containing an unsaturated double bond or an unsaturated triple bond. Examples of the radical-polymerizable group include a vinyl group, a vinylidene group, a vinylene group, an ethynyl group, an allyl group, an isopropenyl group, a 1-butenyl group, a 2-butenyl group, an acryloyl group, a methacryloyl group, a fumaroyl group, a maleoyl group, an acryloyloxy group, a methacryloyloxy group, a vinylphenyl group, a fluorovinyl group, a vinyl ether group, an allyl ether group, a styryl group, a vinylnaphthyl group, a norbornyl group, a cinnamoyl group, and a maleimide group (a 2,5-dihydro-2,5-dioxo-1H-pyrrol-1-yl group). Among these, the radical-polymerizable group is preferably a vinyl group, a vinylidene group, an isopropenyl group, an acryloyl group, a methacryloyl group, or a styryl group.

As the compound C. for example, a radical-polymerizable compound containing at least one atom selected from the group consisting of an oxygen atom and a nitrogen atom can be used.

More specifically, examples of the compound C include a (meth)acrylic radical-polymerizable compound having one or two or more acryloyl groups and/or methacryloyl groups; a styrenic radical-polymerizable compound having one or two or more vinyl groups or vinylidene groups directly bonded to an aromatic carbon atom and containing at least one atom selected from the group consisting of an oxygen atom and a nitrogen atom; an allylic radical-polymerizable compound having one or two or more allyl groups and containing at least one atom selected from the group consisting of an oxygen atom and a nitrogen atom; and a maleimide-based radical-polymerizable compound having one or two or more maleimide groups.

Examples of the compound C include a maleimide compound, a bismaleimide compound, and a compound having two or more structures (ether structures) represented by the following Formula (A) in the molecule and having a heterocyclic structure.

The maleimide compound and the bismaleimide compound may be polymers, and may have other structures (for example, an indane skeleton) in the structure.

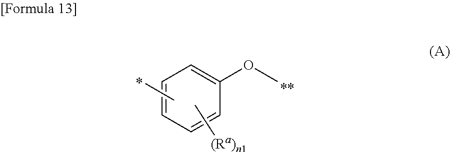

In Formula (A), each Ra is independently a hydroxyl group, a halogen group, a substituted or unsubstituted C6-C20 aromatic hydrocarbon group, a substituted or unsubstituted C1-C20 alkyl group, a substituted or unsubstituted C5-C20 cycloalkyl group, or a substituted or unsubstituted C7-C20 aralkyl group, n1 represents an integer of 0 to 4, and * and ** each represent a bonding position. 25 In the compound having the structure represented by Formula (A) and a heterocyclic structure, bonding positions of bonding groups such as Ra bonded to the benzene ring of Formula (A) are not particularly limited, as long as the ether structure described above is present.

Examples of the halogen group represented by R^{a} include —F, —Cl, —Br, and —I.

Examples of the C6-C20 aromatic hydrocarbon group (the total number of carbon atoms including the number of carbon atoms of the substituent), which may have a substituent, include monovalent aromatic hydrocarbon groups such as a phenyl group, a naphthyl group, and a biphenyl group. Examples of the substituent of the aromatic hydrocarbon group include alkyl groups such as a methyl group, an ethyl group, a propyl group, and a butyl group, a hydroxyl group, and a halogen group, but are not limited thereto.

Examples of the C1-C20 alkyl group (the total number of carbon atoms including the number of carbon atoms of the substituent), which may have a substituent, include linear or branched groups such as a methyl group, an ethyl group, a propyl group, a butyl group, a pentyl group, and a hexyl group. Examples of the substituent of the alkyl group include a hydroxyl group and a halogen group, but are not limited thereto.

Examples of the C5-C20 cycloalkyl group (the total number of carbon atoms including the number of carbon atoms of the substituent), which may have a substituent, include a cyclopentyl group and a cyclohexyl group. Examples of the substituent of the cycloalkyl group include alkyl groups such as a methyl group, an ethyl group, a propyl group, and a butyl group, a hydroxyl group, and a halogen group, but are not limited thereto.

Examples of the C7-C20 aralkyl group (the total number of carbon atoms including the number of carbon atoms of the substituent), which may have a substituent, include a phenylmethyl group, a phenylethyl group, a phenylpropyl group, and a diphenylmethyl group. Examples of the substituent of the aralkyl group include a hydroxyl group and a halogen group, but are not limited thereto.

In Formula (A), n1 is an integer of 0 to 4, preferably 0 to 3, and more preferably 0 or 1, from the viewpoint of achieving both polymerizability and heat resistance.

The compound C preferably has, as the structure represented by Formula (A), a structure represented by the following Formula (B). From the viewpoint of environmental issues, the structure represented by Formula (A) and the structure represented by the following Formula (B) preferably contain no halogen atom.

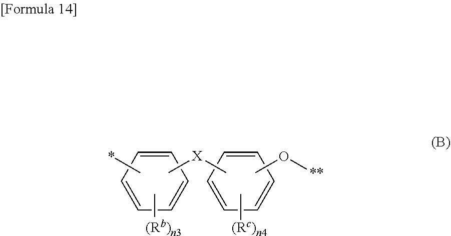

In Formula (B),

R^{b} and R^{c} are each independently a hydroxyl group, a halogen group, a substituted or unsubstituted C6-C20 aromatic hydrocarbon group, a substituted or unsubstituted C1-C20 alkyl group, a substituted or unsubstituted C5-C20 cycloalkyl group, or a substituted or unsubstituted C7-C20 aralkyl group, n3 and n4 each independently represent an integer of 0 to 4, X is a single bond, a substituted or unsubstituted C6-C20 aromatic hydrocarbon group, a substituted or unsubstituted C1-C20 alkylene group, a substituted or unsubstituted C5-C20 cycloalkylene group, a substituted or unsubstituted C1-C20 alkylidene group, a substituted or unsubstituted C5-C20 cycloalkylidene group, a substituted or unsubstituted C8-C20 aralkylene group, a substituted or unsubstituted C7-C20 aralkylidene group, or a group obtained by combining these groups, and

* and ** each represent a bonding position.

A halogen group, a substituted or unsubstituted C6-C20 aromatic hydrocarbon group, a substituted or unsubstituted C1-C20 alkyl group, a substituted or unsubstituted C5-C20 cycloalkyl group, and a substituted or unsubstituted C7-C20 aralkyl group, represented by R^{b} and R^{c}, including preferred embodiments thereof, are the same as those described for Formula (A), and thus description thereof is omitted.

In Formula (3), n3 and n4 are real numbers of 0 to 4, and are preferably 0 to 3, and more preferably 0 or 1, from the viewpoint of heat resistance.

In Formula (B), the bonding positions of bonding groups such as R^{b} and R^{c} bonded to the benzene ring structure are not particularly limited.

Examples of the C6-C20 aromatic hydrocarbon group represented by X (the total number of carbon atoms including the number of carbon atoms of the substituent), which may have a substituent, include divalent aromatic hydrocarbon groups such as a phenylene group, a naphthylene group, a biphenylene group, a divalent fluorene group (for example, a 9,9-fluorene group), and a divalent anthracene group. The aromatic hydrocarbon group may be a monocyclic aromatic hydrocarbon group or a polycyclic aromatic hydrocarbon group. Examples of the substituent of the aromatic hydrocarbon group include alkyl groups such as a methyl group, an ethyl group, a propyl group, and a butyl group, a hydroxyl group, and a halogen group, but are not limited thereto.

Examples of the C1-C20 alkylene group (the total number of carbon atoms including the number of carbon atoms of the substituent), which may have a substituent, include a methylene group, an ethylene group, an n-propylene group, an isopropylene group, an n-butylene group, and an isobutylene group. Examples of the substituent of the alkylene group include a hydroxyl group and a halogen group, but are not limited thereto.

Examples of the C5-C20 cycloalkylene group (the total number of carbon atoms including the number of carbon atoms of the substituent), which may have a substituent, include a cyclopentylene group and a cyclohexylene group. Examples of the substituent of the cycloalkylene group include alkyl groups such as a methyl group, an ethyl group, a propyl group, and a butyl group, a hydroxyl group, and a halogen group, but are not limited thereto. Examples of the cycloalkylene group having a substituent include a 3,3,5-trimethylcyclohexylene group.

Examples of the C1-C20 alkylidene group (the total number of carbon atoms including the number of carbon atoms of the substituent), which may have a substituent, include an ethylidene group and a hexylidene group. Examples of the substituent of the alkylidene group include a hydroxyl group and a halogen group, but are not limited thereto.

Examples of the C5-C20 cycloalkylidene group (the total number of carbon atoms including the number of carbon atoms of the substituent), which may have a substituent, include a cyclopentylidene group and a cyclohexylidene group. Examples of the substituent of the cycloalkylidene group include alkyl groups such as a methyl group, an ethyl group, a propyl group, and a butyl group, a hydroxyl group, and a halogen group, but are not limited thereto.

Examples of the C8-C20 aralkylene group (the total number of carbon atoms including the number of carbon atoms of the substituent), which may have a substituent, include a phenyldimethylene group, a naphthyldimethylene group, and a biphenyldimethylene group. Examples of the substituent of the aralkylene group include alkyl groups such as a methyl group, an ethyl group, a propyl group, and a butyl group, a hydroxyl group, and a halogen group, but are not limited thereto.

Examples of the C7-C20 aralkylidene group (the total number of carbon atoms including the number of carbon atoms of the substituent), which may have a substituent, include a phenylmethylidene group, a phenylethylidene group, and a phenylpropylidene group. Examples of the substituent of the aralkylidene group include alkyl groups such as a methyl group, an ethyl group, a propyl group, and a butyl group, a hydroxyl group, and a halogen group, but are not limited thereto.

Examples of the group represented by X formed by combining these groups include a divalent group obtained by combining at least two selected from the above-described aromatic hydrocarbon group, alkylene group, cycloalkylene group, alkylidene group, cycloalkylidene group, aralkylene group, and aralkylidene group. The bonding positions and arrangement of each group are not particularly limited and can be appropriately set.

The heterocyclic structure of the compound C is not particularly limited; however, it is preferably a heterocyclic structure containing at least one atom selected from the group consisting of a nitrogen atom and an oxygen atom, which may have a substituent, that is, a substituted or unsubstituted nitrogen-containing heterocyclic structure, an oxygen-containing heterocyclic structure, or an oxygen- and nitrogen-containing heterocyclic structure, and more preferably a substituted or unsubstituted nitrogen-containing heteroaromatic ring structure.

Examples of the heterocycle of the compound C include a pyrrole ring, a pyrrolidine ring, a pyridine ring, a pyrimidine ring, a pyrazine ring, a pyridazine ring, a triazine ring, a quinoline ring, an isoquinoline ring, a quinoxaline ring, a phthalazine ring, a quinazoline ring, a naphthyridine ring, a carbazole ring, an acridine ring, a phenazine ring, a piperidine ring, a tetrahydropyran ring, a morpholine ring, a tetrahydrofuran ring, a furan ring, an oxazole ring, an oxazolidine ring, an oxazine ring, and an oxetane ring. From the viewpoints of reactivity and solubility in various organic solvents, the heterocycle is preferably a pyrimidine ring or a triazine ring.

The bonding position of the heterocycle with another structure (for example, the structure represented by Formula (A) described above) is not particularly limited; however, when the heterocycle is bonded to two other structures, that is, when two bonding sites are present, the bonding sites are preferably at the meta positions from the viewpoint of reactivity.

Examples of the substituent of the heterocyclic structure include a halogen group, a C1-C20 hydrocarbon group, a C1-C20 halogenated hydrocarbon group, a group in which a part of these hydrocarbon groups or halogenated hydrocarbon groups is substituted with at least one atom selected from an oxygen atom and a sulfur atom, a nitro group, a cyano group, an amino group, and a salt of an amino group.

Examples of the halogen group as the substituent include —F, —Cl, —Br, and —I.

Examples of the C1-C20 hydrocarbon group as the substituent include a chain hydrocarbon group, an alicyclic hydrocarbon group, and an aromatic hydrocarbon group.

Examples of the chain hydrocarbon group include alkyl groups such as a methyl group. an ethyl group, an n-propyl group, an isopropyl group, an n-butyl group, an isobutyl group, a sec-butyl group, a tert-butyl group, and an n-pentyl group; alkenyl groups such as an ethenyl group, a propenyl group, a butenyl group, and a pentenyl group; and alkynyl groups such as an ethynyl group, a propynyl group, a butynyl group, and a pentynyl group.

Examples of the alicyclic hydrocarbon group include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the aromatic hydrocarbon group include aryl groups such as a phenyl group, a tolyl group, a xylyl group, a naphthyl group, and an anthryl group; and aralkyl groups such as a benzyl group, a phenethyl group, a phenylpropyl group, and a naphthylmethyl group.

Examples of the C1-C20 halogenated hydrocarbon group as the substituent include a group in which a part or all of hydrogen atoms of the C1-C20 hydrocarbon group are substituted with halogen atoms such as a fluorine atom, a chlorine atom, a bromine atom, or an iodine atom.

Examples of the group in which a part of the substituent that is a C1-C20 hydrocarbon group or a C1-C20 halogenated hydrocarbon group is substituted with at least one selected from an oxygen atom and a sulfur atom include a group in which a part of the hydrocarbon group or the halogenated hydrocarbon group is substituted with —O—, —S—, an ester group, or a sulfonyl group.

The amino group as the substituent is not particularly limited, and may be a primary amino group (—NH₂), a secondary amino group (—NHR), or a tertiary amino group (—NR₂).

The substituent (R) in the secondary amino group and the tertiary amino group is not particularly limited, and examples thereof include the above-described C1-C20 hydrocarbon groups.

The anion constituting the anionic moiety of the salt of the amino group is not particularly limited, and examples thereof include known anions such as Cl⁻.

From the viewpoints of reactivity and solubility, the substituents on the heterocyclic structure are preferably a halogen group, a C1-C6 hydrocarbon group, a C1-C6 halogenated hydrocarbon group, a nitro group, a cyano group, an amino group, or a salt of an amino group, and more preferably a fluorine atom, a chlorine atom, a methyl group, a nitro group, a cyano group, a tert-butyl group, a phenyl group, and a primary amino group.

From the viewpoints of heat resistance and electrical properties, the heterocyclic structure is preferably a structure selected from the structures represented by the following Formulas (C) to (E), and more preferably a structure represented by Formula (C).

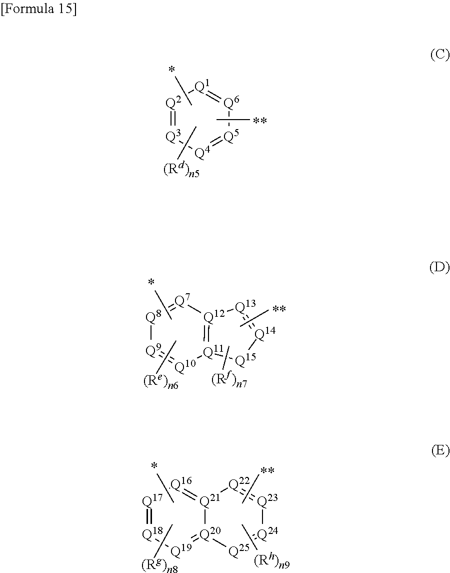

In Formulas (C) to (E),
R^{d} to R^{h} are each independently a substituted or unsubstituted C1-C20 alkyl group or a substituted or unsubstituted C6-C20 aromatic hydrocarbon group,
n5 represents an integer of 0 to 4,
n6, n8, and n9 each independently represent an integer of 0 to 3,
n7 represents an integer of 0 to 2,
Q¹ to Q²⁵ are each independently a nitrogen atom or a carbon atom, provided that at least one of Q¹ to Q⁶ is a nitrogen atom, at least one of Q⁷ to Q¹⁵ is a nitrogen atom, at least one of Q¹⁶ to Q25 is a nitrogen atom, and when at least one of Q¹¹ and Q¹² is a nitrogen atom, the bond between Q¹¹ and Q¹², and the bond between Q⁷ and Q¹² and the bond between Q¹² and Q¹³, or the bond between Q¹⁰ and Q¹¹ and the bond between Q¹¹ and Q¹⁵, are single bonds, and when at least one of Q²⁰ and Q²¹ is a nitrogen atom, the bond between Q²⁰ and Q²¹ and the bond between Q¹⁶ and Q²¹ and the bond between Q²¹ and Q²², or the bond between Q¹⁹ and Q²⁰ and the bond between Q²⁰ and Q²⁵, are single bonds, and
* and ** are each a bonding position.
Examples of the C1-C20 alkyl groups represented by R^{d} to R^{h} include a methyl group, an ethyl group, an n-propyl group, an isopropyl group, an n-butyl group, an isobutyl group, a sec-butyl group, a tert-butyl group, and an n-pentyl group.

Examples of the C6-C20 aromatic hydrocarbon groups represented by R^{d} to R^{h} include aryl groups such as a phenyl group, a tolyl group, a xylyl group, a naphthyl group, and an anthryl group; and aralkyl groups such as a benzyl group, a phenethyl group, a phenylpropyl group, and a naphthylmethyl group.
Examples of substituents that the alkyl group and the aromatic hydrocarbon group represented by R^{d} to R^{h} may have include those same as the substituents of the heterocyclic structure described above.

n5 is an integer of 0 to 4, and is preferably 0 to 3, and more preferably 0 to 2, from the viewpoint of polymerizability.
n6, n8, and n9 are each independently an integer of 0 to 3, and are preferably 0 to 2, and more preferably 0 or 1. from the viewpoint of polymerizability.
n7 is an integer of 0 to 2, and is preferably 0 or 1 from the viewpoint of polymerizability.

In Formulas (C) to (E), the bonding positions of bonding groups such as R^{d} to R^{h} bonded to the cyclic structure are not particularly limited.

As described above, in the heterocyclic structures represented by Formulas (C) to (E), the arrangement of nitrogen atoms is not particularly limited, and accordingly, the positions of double bonds in the ring structure can be appropriately selected and are not particularly limited.

The compound C can be represented by, for example, structures represented by the following Formulas (F) and (Z).

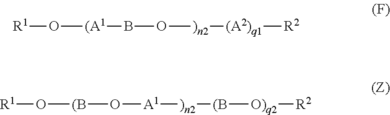

In Formulas (F) and (Z),
R¹ and R² are each independently a C2-C50 group containing an ethylenically unsaturated double bond, a substituted or unsubstituted C6-C50 aromatic hydrocarbon group, a substituted or unsubstituted C6-C50 aliphatic hydrocarbon group, or a substituted or unsubstituted nitrogen-containing heteroaromatic ring,
A¹ and A² are each independently a group having a structure represented by Formula (A) or a group having a structure represented by Formula (B), provided that, in Formula (F), ** in Formulas (A) and (B) represents a bonding position with B or R², and in Formula (Z), ** in Formulas (A) and (B) represents a bonding position with B or R
each B is independently a divalent group having a nitrogen-containing heterocyclic structure,
each n2 is independently an integer of 1 or more,
q1 is 0 or 1, and when q1 is 0, (A²)_{q1} represents a single bond, and
q2 is 0 or 1, and when q2 is 0, (B—O)_{q2} represents a single bond.

Examples of the C2-C50 group containing an ethylenically unsaturated double bond represented by R¹ and R² include aromatic ring-containing groups such as a 3-isopropenylphenyl group, a 4-isopropenylphenyl group, a 2-allylphenyl group, a 2-methoxy-4-allylphenyl group, a 4-(1-propenyl)-2-methoxyphenyl group, a 3-isopropenylbenzyl group, a 4-isopropenylbenzyl group, a 4-vinylbenzyl group, a 3-vinylbenzyl group, and a 2-vinylbenzyl group, an allyl group, an acryl group, and a methacryl group.

Examples of the C6-C50 aromatic hydrocarbon group include aryl groups such as a phenyl group, a biphenyl group, a tolyl group, a xylyl group, a naphthyl group, and an anthryl group; and aralkyl groups such as a benzyl group, a phenethyl group, a phenylpropyl group, and a naphthylmethyl group.

Examples of the C6-C50 aliphatic hydrocarbon group include monocyclic cycloalkyl groups such as a cyclopropyl group, a cyclobutyl group, a cyclopentyl group, and a cyclohexyl group; polycyclic cycloalkyl groups such as a norbornyl group and an adamantyl group; monocyclic cycloalkenyl groups such as a cyclopropenyl group, a cyclobutenyl group, a cyclopentenyl group, and a cyclohexenyl group; and polycyclic cycloalkenyl groups such as a norbornenyl group.

Examples of the nitrogen-containing heteroaromatic ring include the same rings as those exemplified in the heterocyclic structures described above.

Examples of substituents that R¹ and R² may have include groups other than a hydroxy group, and specific examples thereof include an allyl group, a halogen group, a C1-C20 hydrocarbon group, a C1-C20 halogenated hydrocarbon group, a C1-C20 alkoxy group, a C1-C20 alkylthio group, a nitro group, a cyano group, a carboxy group, a sulfonic acid group, a phosphonic acid group, a phosphoric acid group, a hydroxy group, a primary to tertiary amino group, a salt of a carboxy group, a salt of a sulfonic acid group, a salt of a phosphonic acid group, a salt of a phosphoric acid group, a salt of a hydroxy group, or a salt of a primary to tertiary amino group. Among these, an allyl group is preferable.

Examples of the halogen group, the C1-C20 hydrocarbon group, and the C1-C20 halogenated hydrocarbon group as the substituent include the same groups as those exemplified for the substituents of the heterocyclic structure described above.

Examples of the C1-C20 alkoxy group include a methoxy group, an ethoxy group, an n-propoxy group, an isopropoxy group, a butoxy group, a pentyloxy group, a hexyloxy group, and an octyloxy group.

Examples of the C1-C20 alkylthio group include a methylthio group, an ethylthio group, an n-propylthio group, an isopropylthio group, a butylthio group, a pentylthio group, a hexylthio group, and an octylthio group.

The substituent (R) in the secondary amino group (—NHR) and the tertiary amino group (—NR₂) is not particularly limited, and examples thereof include a C1-C20 hydrocarbon group. Specific examples thereof include the same groups as those exemplified as substituents of the heterocyclic structure described above.

The cation constituting the cationic moiety of a salt of a carboxy group, a salt of a sulfonic acid group, a salt of a phosphonic acid group, a salt of a phosphoric acid group, and a salt of a hydroxy group is not particularly limited, and examples thereof include known cations such as Na⁺.

The anion constituting the anionic moiety of the salt of the amino group is not particularly limited, and examples thereof include known anions such as Cl⁻.

The group represented by A¹ and A² and having the structure represented by Formula (A) is preferably the group represented by Formula (B) described above. In this case, in Formula (F), * in Formula (B) represents a bonding position with O, and ** represents a bonding position with B or R². Similarly, in the case of Formula (Z), * in Formula (B) represents a bonding position with O, and ** represents a bonding position with B or R².

In addition, the divalent group having a nitrogen-containing heterocyclic structure represented by B is preferably a group selected from the structures represented by Formulas (C) to (E) described above. In this case, * and ** in Formulas (C) to (E) each represent a bonding position with A¹ or O in Formula (F), and a bonding position with O, A¹, or R² in Formula (Z).

n2 is an integer of 1 or more, for example, an integer of 1 to 100.

In addition, the compound C is preferably a compound represented by the following Formula (G).

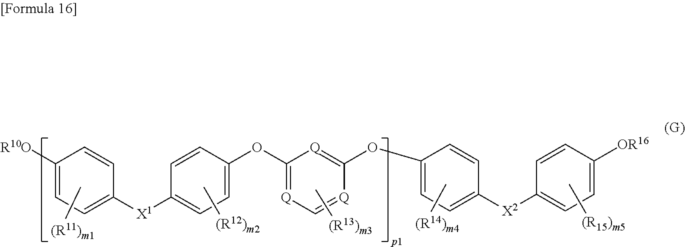

In Formula (G),
R¹⁰ and R¹⁶ are each independently a C2-C50 group containing an ethylenically unsaturated double bond, a substituted or unsubstituted C6-C50 aromatic hydrocarbon group, a substituted or unsubstituted C6-C50 aliphatic hydrocarbon group, or a substituted or unsubstituted nitrogen-containing heteroaromatic ring,
R¹¹, R¹², R¹⁴, and R¹⁵ are each independently a hydroxyl group, a halogen group, a substituted or unsubstituted C6-C20 aromatic hydrocarbon group, a substituted or unsubstituted C1-C20 alkyl group, a substituted or unsubstituted C5-C20 cycloalkyl group, or a substituted or unsubstituted C7-C20 aralkyl group,
each R¹³ is independently a substituted or unsubstituted C1-C20 alkyl group or a substituted or unsubstituted C6-C20 aromatic hydrocarbon group,
X¹ and X² are each independently a single bond, a substituted or unsubstituted C6-C20 aromatic hydrocarbon group, a substituted or unsubstituted C1-C20 alkylene group, a substituted or unsubstituted C5-C20 cycloalkylene group, a substituted or unsubstituted C1-C20 alkylidene group, a substituted or unsubstituted C5-C20 cycloalkylidene group, a substituted or unsubstituted C8-C20 aralkylene group, a substituted or unsubstituted C7-C20 aralkylidene group, or a group obtained by combining these groups,
each Q is independently a nitrogen atom or a carbon atom, provided that at least two of Q are nitrogen atoms, and
m1, m2, m4, and m5 are real numbers of 0 to 4, preferably 0 to 2, and more preferably 0 or 1, from the viewpoints of polymerizability and heat resistance.
m3 is an integer of 0 to 2, and is preferably 0 or 1, from the viewpoints of polymerizability and heat resistance.
p1 is an integer of 1 or more, for example, an integer of 1 to 100.

Each structure represented by R¹⁰ and R¹⁶ is the same as R¹ and R² in Formula (F) described above, and preferred embodiments thereof are also the same. In addition, each structure represented by R¹¹, R¹², R¹⁴, and R¹⁵ is the same as R^{b} and R^{c} in Formula (B) described above, and preferred embodiments thereof are also the same. Furthermore, each structure represented by R¹³ is the same as R^{d} to R^{h} in Formulas (C) to (E) described above, and preferred embodiments thereof are also the same. In addition, each structure represented by X¹ and X² is the same as X in Formula (B) described above, and preferred embodiments thereof are also the same.

In addition, the compound C is particularly preferably a compound represented by the following Formula (G-1).

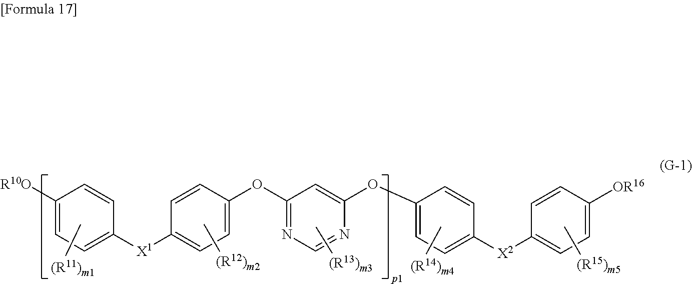

In Formula (G-1),
R¹⁰ to R¹⁶, X¹ and X², m1 to m5, and p1 are the same as those shown in Formula (G) described above, and preferred embodiments thereof are also the same.

For example, the following compounds can also be used as the compound C.

A modified polyphenylene ether (PPE) resin; a vinylbenzyl ether resin; a curable resin having a heterocyclic ether bond such as a triazine ether in a main chain; a polyfunctional methacrylate compound having two or more methacryl groups in the molecule; a polyfunctional acrylate compound having two or more acryl groups in the molecule; a trialkenyl isocyanurate compound such as triallyl isocyanurate (TAIC); a polyfunctional acrylate compound; and a polyfunctional methacrylate compound can also be used as the compound C. The vinylbenzyl ether resin (a compound having a vinylbenzyl ether group) can be synthesized, for example, by reacting a phenolic resin such as a biphenyl aralkyl-type phenol, an aralkyl phenol, or a naphthol aralkyl resin with chloromethylstyrene in the presence of an alkaline catalyst. Examples of the modified PPE resins include, for example, trade name: Noryl (registered trademark) SA-9000, manufactured by SABIC Innovative Plastics.

From the viewpoint of heat resistance, a content ratio of the compound C in the solid content of the present composition is preferably 1 mass % or more, more preferably 3 mass % or more, and still more preferably 5 mass % or more. In addition, from the viewpoint of electrical properties, the content ratio of the compound C in the solid content of the present composition is preferably 80 mass % or less. more preferably 70 mass % or less, still more preferably 50 mass % or less, even more preferably 40 mass % or less, and particularly preferably 30 mass % or less.

### (Other Components)

The present composition can further contain other curable resins other than the resin A, flame retardants other than the above-described organophosphorus compound, and additives such as a crosslinking agent, a filler, and an elastomer. In addition, the present composition may also contain a polymerization initiator such as dicumyl peroxide, 2,3-dimethyl-2,3-diphenylbutane (CCDFB), or an azo initiator. The other components do not include those corresponding to the above-described resin A, compound B, and compound C. In addition, also in the other components, from the viewpoint of environmental issues, it is preferable that halogen materials are not contained.

The present composition can be used in combination with other curable resins as necessary. As the other curable resins, conventionally known resins can be appropriately used; for example, ODV and a soluble divinylbenzene polymer can be used.

By curing the present composition with a crosslinking agent added thereto. a cured composition with excellent properties can be obtained.

Examples of the crosslinking agent include compounds having, in the molecule, reactive functional groups such as a styryl group (St group) and an allyl group. From the viewpoint of reactivity with the present composition, the reactive functional group is preferably a styryl group. More specifically, from the viewpoint of electrical properties, the crosslinking agent is preferably 1,2-bis(vinylphenyl)ethane (BVPFE), a fluorene compound having a vinylbenzyl group described in Japanese Patent No. 3681170, an indene compound having a vinylbenzyl group, vinyl compounds such as divinylbenzene, and the like, and more preferably BVPE. The crosslinking agent may be a mixture of two or more kinds, or may be a compound having repeating units (polymer), and for example, a vinyl compound represented by the following Formula (H) or a vinyl compound represented by the following Formula (1) can be used.

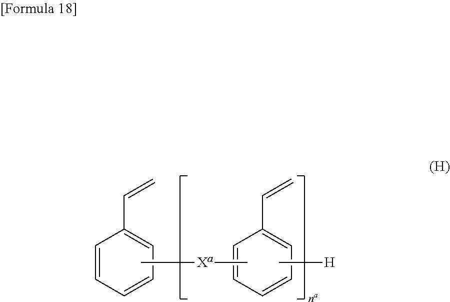

In Formula (H), X^{a} represents a hydrocarbon group having 6 or more carbon atoms and containing at least one selected from an aromatic cyclic group and an aliphatic cyclic group, and n^{a} represents an integer of 1 to 10.

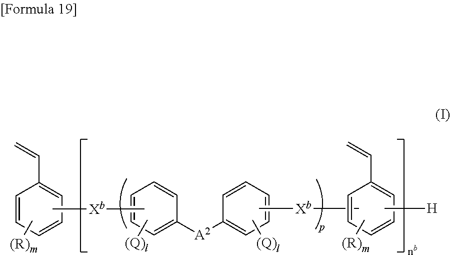

In Formula (I), X^{b} represents one or more selected from (a) to (h) described in the following Formula (J). Here, when a plurality of X^{b} are present, the plurality of X^{b} may be the same as or different from each other. A² represents a methylene group or an oxygen atom, and Q represents a C1-C10 hydrocarbon group or a halogenated alkyl group. The plurality of Q may be the same as or different from each other. R represents a C1-C10 hydrocarbon group or a halogenated alkyl group. When a plurality of R are present, the plurality of R may be the same as or different from each other. 1 and in each represent an integer of 0 to 3, n^{b} represents a repeating unit and satisfies 1≤n^{b}≤20, and p represents a repeating unit and satisfies 1.1≤p≤20.

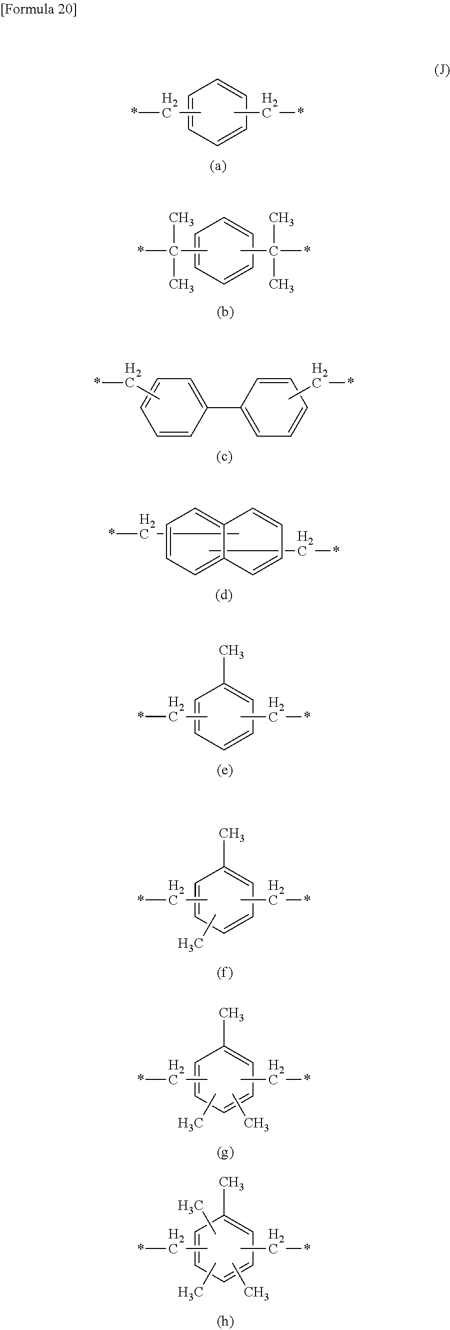

In Formula (11), each * represents a bonding position.

Examples of the crosslinking agent include a compound obtained by reacting a compound having fluorene or indene as a partial skeleton with a halogenated compound having a styryl group (St group), such as chloromethylstyrene, in the presence of an alkaline catalyst. In the reaction, a phase-transfer catalyst may be used, and the solvent is preferably a non-protic organic solvent or a solvent containing a non-protic organic catalyst. More specifically, examples of the crosslinking agent include a compound represented by the following Formula (K), which is obtained by reacting a compound having fluorene as a partial skeleton with chloromethylstyrene.

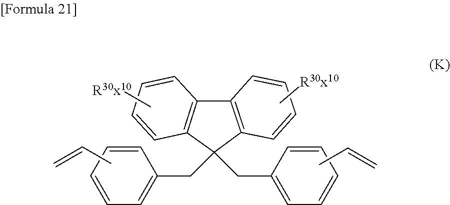

In Formula (K), R³⁰ represents a hydrogen atom, a C1-C10 hydrocarbon group, or a halogenated alkyl group, and X¹⁰ represents an integer of 0 to 4.

In addition, as the crosslinking agent, a vinyl compound (a polyfunctional vinyl compound) having two or more vinyl groups in the molecule, such as polybutadiene or a styrene-butadiene copolymer; a polyfunctional aromatic copolymer obtained by copolymerizing divinylbenzene with a styrene derivative; and a vinylbenzyl compound such as styrene or divinylbenzene having a vinylbenzyl group in the molecule may be used. Among these, those having two or more carbon-carbon double bonds in the molecule are preferable. Specific examples thereof include a polyfunctional aromatic copolymer and a divinylbenzene compound. By using these compounds, it is considered that crosslinking is more suitably formed by a curing reaction, and the heat resistance of a cured product of the present composition can be further enhanced. In addition, the exemplified crosslinking agents may be used alone, or two or more kinds thereof may be used in combination. In addition, as the crosslinking agent, a compound having two or more carbon-carbon unsaturated double bonds in the molecule may be used in combination with a compound having one carbon-carbon unsaturated double bond in the molecule. Specific examples of the compound having one carbon-carbon unsaturated double bond in the molecule include compounds having one vinyl group in the molecule (monovinyl compounds).

The average number of carbon-carbon unsaturated double bonds per molecule of the crosslinking agent (number of terminal double bonds) varies depending on the weight average molecular weight of the crosslinking agent; however, from the viewpoint of heat resistance of the cured product, it is preferably I or more, and more preferably 2 or more. In addition, the number of terminal double bonds per molecule of the crosslinking agent is preferably 20 or less, and more preferably 18 or less, from the viewpoints of reactivity, storage stability of the composition, and fluidity.

Considering the weight average molecular weight of the crosslinking agent, when the weight average molecular weight of the crosslinking agent is less than 500 (for example, 100 or more and less than 500), the number of terminal double bonds of the crosslinking agent is preferably 1 to 4. In addition. when the weight average molecular weight of the crosslinking agent is 500 or more (for example, 500 or more and 5,000 or less), the number of terminal double bonds of the crosslinking agent is preferably 3 to 20. In each case, when the number of terminal double bonds is equal to or greater than the lower limit of the above range, the crosslinking agent tends to have excellent reactivity, an appropriate crosslinking density is easily imparted to a cured product of the resin composition, and heat resistance and Tg can be readily improved. On the other hand, when the number of terminal double bonds is equal to or less than the upper limit of the above range, gelation of the composition can be easily prevented.

The number of terminal double bonds of the crosslinking agent can be determined from the product specification values of the crosslinking agent used. As used herein, the number of terminal double bonds refers to a value representing the average number of double bonds per molecule of the crosslinking agent, calculated for all crosslinking agent molecules present in one mole of the crosslinking agent.

Examples of the other flame retardant include a halogen-based flame retardant such as a bromine-based flame retardant. The flame retardant may be used alone, or two or more kinds thereof may be used in combination. However, from the viewpoint of environmental issues, it is preferable that the present composition contains no halogen material. When a halogen-based flame retardant is used as the flame retardant, for example, SAYTEX8010 (trade name, manufactured by Albemarle Corporation) can be used. These compounds can be produced by conventionally known methods. A commercially available product may be used as the halogen-based flame retardant. The structure of SAYTEX8010 is as follows.

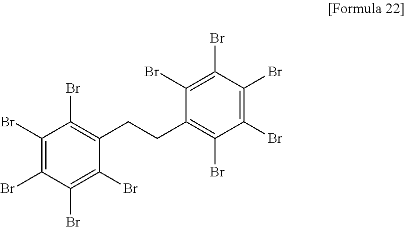 [SMILES: Brc1c(Br)c(Br)c(CCc2c(Br)c(Br)c(Br)c(Br)c2Br)c(Br)c1Br]

As the filler, silica, hollow silica, or the like can be used. From the viewpoint of dielectric properties, the filler preferably has a small amount of silanol groups. In addition, when silica is hollow, a composition having a low dielectric constant can be obtained. Silica having a surface subjected to a modification treatment can also be used. Specifically, silica subjected to a treatment with a functional group containing a carbon-carbon unsaturated double bond and/or to a trimethylsilylation treatment can be used.

Examples of the elastomer include styrene-based elastomers, and usable examples thereof include a styrene-butadiene-styrene copolymer, a hydrogenated styrene-butadiene-styrene copolymer, a styrene-isoprene-styrene copolymer, a hydrogenated styrene-isoprene-styrene copolymer, and a hydrogenated styrene-(butadiene/isoprene)-styrene copolymer.

In addition to the above, the present composition can further contain, as necessary, acenaphithylene and indene, and derivatives thereof. The mixing ratio of these components can be set to 75 mass % or less with respect to the present composition.

Furthermore, the present composition may contain a fluororesin. From the viewpoint of improving adhesion, the fluororesin may have a functional group.

In addition, in the present composition, a total content of oxygen atoms and nitrogen atoms contained in organic materials excluding an inorganic filler in the present composition can be, for example, 0.01 to 10 mass %. The content can be determined by measurement using elemental analysis by a combustion method, or, when raw materials having known structures are used, can be calculated.

### <Method for Producing Resin Composition>

The present composition can be prepared by mixing the above-described resin A. the organophosphorus compound (compound B), and the compound C, and, as necessary, various additives.

### <Method for Producing Resin A>

The resin A can be obtained, for example, by polymerizing a compound having a plurality of isopropenyl groups (for example, a diisopropenyl compound) in the presence of an acid catalyst at a reaction temperature of 10 to 75° C.

As described above, the resin A can have, in addition to the α-olefin structure represented by Formula (1) described above, the above-described terminal olefin structure, side-chain olefin structure, indane structure represented by Formula (2), inner olefin structure represented by Formula (3), and the like. Here, each of these structures is formed by reactions between molecules having isopropenyl groups in the raw materials, and the indane structure is predominant in terms of equilibrium (thermodynamics), whereas the α-olefin structure is kinetically predominant. Therefore, the mixing ratio of each structure included in the resin A can be controlled by reaction conditions such as the kind of catalyst and temperature conditions.

Here, the compound having a plurality of isopropenyl groups is a compound having two or more isopropenyl groups in one molecule. As the compound, as described above, a compound produced by a conventionally known method can be used, and for example, diisopropenylbenzene compounds such as 1,3-diisopropenylbenzene and 1,4-diisopropenylbenzene can be used. In addition, as such a compound, a precursor thereof (for example, α, α, α′, α′-tetramethyl-1,3-benzenedimethanol) can also be used.

In the method for producing the resin A, another compound may be copolymerized together with the compound having a plurality of isopropenyl groups. That is, the resin A may be a homopolymer of the compound having a plurality of isopropenyl groups, or may be a copolymer obtained by using a plurality of compounds including the compound.

Examples of the other compound include a monovinyl compound and a divinyl compound. More specifically, as the other compound, α-methylstyrene, an α-methylstyrene dimer, α-olefin compounds such as diphenylethylene, a monoisopropenyl compound, a cyclic diene, or the like can be used. For example, the monoisopropenyl compound can be used as a terminator that terminates the propagation reaction.

In addition, from the viewpoints of physical property adjustment and molecular weight control by functional group introduction, structures such as a phenol structure, an aromatic amine structure, an aromatic ether structure, and a maleimide structure may be introduced into the resin A. When introducing such structures, these structures are preferably introduced into the structure by utilizing an electrophilic substitution reaction by a cation generated from an isopropenyl group of a raw material during the polymerization reaction.

However, as described above, the resin A does not necessarily contain heteroatoms other than carbon atoms and hydrogen atoms.

The water content in the raw materials for obtaining the resin A, such as monomers, is preferably 500 ppm or less from the viewpoint of reactivity. If necessary, dehydration treatment of the raw materials can be performed using a molecular sieve, alumina, or the like.

Examples of the acid catalyst used in the polymerization reaction include the inorganic acids, solid acids, organic sulfonic acids, Lewis acids, and Bronsted acids shown below. One acid may correspond to a plurality of kinds among inorganic acids, solid acids, organic sulfonic acids, Lewis acids, and Bronsted acids.

Inorganic acids: for example, sulfuric acid, nitric acid, hydrochloric acid, and phosphoric acid

Solid acid: for example, activated clay, acid clay, silica alumina, zeolite, sulfonated carbon, strongly acidic ion-exchange resins, heteropoly acids, and tungstic acid

Organic sulfonic acids: for example, benzenesulfonic acid, toluenesulfonic acid, xylenesulfonic acid, methanesulfonic acid, fluoromethanesulfonic acid, and perfluoroalkanesulfonic acids such as CF₃SO₃H, C₂F₅SO₃H, and C₆F₅SO₃H

Lewis acids: for example, AlCl₃, TiCl₄, SnCl₄, B(C₆F₅)₃, BF₃, and complexes thereof with Lewis bases, methylaluminoxane, metallocene halides and combinations thereof with methylaluminoxane, and combinations thereof

Bronsted acids: for example boric acid, acetic acid, and benzoic acid

As the Lewis base that acts as a cocatalyst component, for example, one or more selected from the group consisting of an ester-based compound, a thioester-based compound, a ketone-based compound, an amine-based compound, an ether-based compound, a thioether-based compound, and a phosphine-based compound can be used.

Ester-based compound: for example, ethyl acetate, propyl acetate, isopropyl acetate, butyl acetate, phenyl acetate, methyl propionate, dimethyl carbonate, diethyl carbonate, and ethylene carbonate

Thioester-based compound: for example, methyl mercaptopropionate and ethyl mercaptopropionate

Ketone-based compound: for example, methyl ethyl ketone, methyl isobutyl ketone, and benzophenone

Amine-based compound: for example, methylamine, ethylamine, propylamine, butylamine, cyclohexylamine, methylethylamine, dimethylamine, diethylamine, dipropylamine, and dibutylamine

Ether-based compound: for example, diethyl ether, methyl tert-butyl ether, diethylene glycol dimethyl ether, propylene glycol dimethyl ether, tetrahydrofuran, and cyclopentyl methyl ether

Thioether-based compound: for example, diethyl sulfide and diphenyl sulfide

Phosphine-based compound: for example, tripropylphosphine, tributylphosphine, trihexylphosphine, tricyclohexylphosphine, trioctylphosphine, vinylphosphine, propenylphosphine, cyclohexenylphosphine, dialkenylphosphine, and trialkenylphosphine

In the method for producing the resin A, from the viewpoints of facilitating formation of an α-olefin structure (and a terminal olefin structure and a side-chain olefin structure) and facilitating control of molecular weight, it is preferable to use a combination (mixture) of one or more selected from the ester-based compound, the ketone-based compound, and the ether-based compound described above, and one or more selected from the acid catalysts described above. Here, examples of the acid catalyst include the Bronsted acids, Lewis acids, organic sulfonic acids, and inorganic acids described above. In addition, from the same viewpoint, as the acid catalyst, it is also preferable to use one selected from the group consisting of methanesulfonic acid, a BF₃ complex, stannic chloride, and toluenesulfonic acid.

The amount of the cocatalyst with respect to the acid catalyst is not particularly limited because it may vary depending on reaction conditions; however, the amount of the cocatalyst is preferably I mol or more with respect to 1 mol of the acid catalyst.

For example, a catalyst mixture of a Lewis acid (for example, BF₃O(C₂H₅)₂) and a Lewis base (for example, isopropyl acetate) can be used as the acid catalyst.

The polymerization reaction can be performed in a solvent. Examples of the solvent include the following solvents. Nonpolar organic solvents such as hexane, decane, dodecane, cyclohexane, benzene, toluene, o-xylene, m-xylene, p-xylene, ethylbenzene, and trimethylbenzene; chlorine-based organic solvents such as methylene chloride, chloroform, carbon tetrachloride, 1,2-dichloroethane, trichloroethane, and perchloroethane. Aromatic compounds such as halogenated benzene, nitrobenzene, and trifluoromethylbenzene. In addition to the solvents, the ester-based compound. the ketone-based compound, and the ether-based compound described above can also be used as the solvent.

In the method for producing the resin A, the reaction temperature in the polymerization reaction is preferably 10 to 75° C. When the reaction temperature is 10° C. or higher, the reaction can be readily completed within an appropriate period of time. In addition, when the reaction temperature is 75° C. or lower, formation of an indane structure and an inner olefin structure can be readily suppressed, and formation of an α-olefin structure, a terminal olefin structure, and a side-chain olefin structure is facilitated.

Here, in the method for producing the resin A, it is preferable to perform an aging reaction after adding a raw material (for example, a diisopropenyl compound) to a reaction solution containing an acid catalyst. Here, the reaction temperature and the reaction time in the polymerization reaction refer to the temperature and the time from when addition of the raw material to the reaction system is started and polymerization of the added raw material is started until the polymerization reaction is completed. That is, the reaction time is started at a stage at which polymerization of a part of all the raw materials is started. On the other hand, the aging temperature and the aging time in the polymerization reaction refer to, respectively, the temperature and the time (in the aging reaction) from after all the raw materials have been completely added to the reaction system (when the raw materials are added to the reaction system by dropwise addition, after completion of dropwise addition of the entire amount) until the reaction is completed. That is, the end point of the reaction time and the end point of the aging time are the same. The polymerization reaction in the method for producing the resin A can be stopped by quenching the reaction system by adding an alkaline material thereto, lowering the temperature in the reaction system, or removing the catalyst by washing with water or the like. At that time, the reaction can be stopped when a desired mixing ratio of each structure is obtained, even if the raw materials remain. When the polymerization reaction is stopped by such a method, the time point at which the reaction is stopped is regarded as the end point of the reaction time and the end point of the aging time.

From the viewpoints of controlling the mixing ratio of the α-olefin structure (and the terminal olefin structure and the side-chain olefin structure), controlling molecular weight, and controlling formation of insoluble components, the aging time is preferably 72 hours or shorter, more preferably 32 hours or shorter, still more preferably 24 hours or shorter, and particularly preferably 12 hours or shorter.

In addition, from the viewpoint of molecular weight control, the aging time is preferably 5 minutes or longer, more preferably 10 minutes or longer, and still more preferably 15 minutes or longer.

In addition, the aging temperature is preferably 10 to 75° C. from the viewpoints of molecular weight control and structure control.

In the method for producing the resin A, the solution containing the polymer after termination of the polymerization reaction can be purified by a known method to obtain a target product (resin A). Examples of the purification method include a method in which a water-soluble compound is washed with water and removed by liquid separation, a method in which a low-boiling compound such as a solvent is distilled off under reduced pressure, and a method in which reprecipitation is performed by mixing with a poor solvent.

The obtained polymer can be further purified by a known method to increase the purity. Examples of the purification method include a method of repeating redissolution and reprecipitation, washing with a poor solvent, drying under reduced pressure, and adsorption treatment using a cation-exchange adsorbent or an anion-exchange adsorbent.

The resin A can be obtained through the above operations. Different curable functional groups such as a hydroxyl group and an amino group can be introduced into the resin A to produce a cured product with a phenolic resin, an epoxy resin, a polyimide resin, or the like, or the present resin can be modified and used as a maleimide resin or a benzoxazine resin.

### (Method for Producing Organophosphorus Compound (Compound B))

The organophosphorus compound may be a commercially available product, or may be produced by a conventionally known method. For example, the organophosphorus compounds shown below can be produced by the following methods.

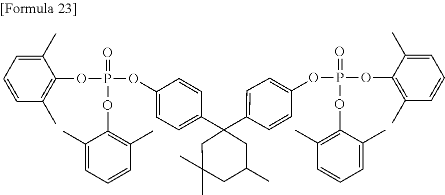 [SMILES: Cc1cccc(C)c1OP(=O)(Oc1ccc(C2(c3ccc(OP(=O)(Oc4c(C)cccc4C)Oc4c(C)cccc4C)cc3)CC(C)CC(C)(C)C2)cc1)Oc1c(C)cccc1C]

First, phosphorus oxy chloride, 2,6-xylenol, xylene as a solvent, and magnesium chloride as a catalyst are reacted under heating conditions (for example, at a temperature of 160° C.) to synthesize the following dixylyl phosphorochloridate. During the reaction, generated hydrogen chloride (hydrochloric acid gas) is collected, and xylene, unreacted phosphorus oxychloride and 2,6-xylenol, by-produced hydrogen chloride, and the like are removed under reduced pressure.

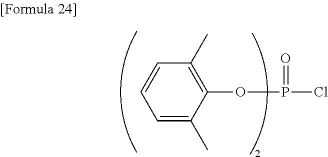

Next, the obtained dixylyl phosphorochloridate and bisphenol are added to toluene and tetrahydrofuran as solvents, and while stirring, triethylamine is added dropwise under heating conditions (for example, at a temperature of 65° C.). Then, the above-described organophosphorus compound can be obtained by performing distillation purification or the like as necessary.

### (Method for Producing Compound C)

A method for producing a compound C is not particularly limited, and a known method can be appropriately used. For example, when the compound C is represented by the structure shown in Formula (F) described above, the compound C can be synthesized by heating, in an organic solvent, a monomer serving as a raw material for a portion including A¹ in Formula (F), a monomer serving as a raw material for a portion including A², a monomer serving as a raw material for a portion including B, a monomer serving as a raw material for a portion including R¹, a monomer serving as a raw material for a portion including R² and, as necessary, another monomer, together with an alkali metal or an alkali metal compound. The monomer serving as a raw material for a portion including A¹ and the monomer serving as a raw material for a portion including A² may be the same monomer or may be different monomers. In addition, the monomer serving as a raw material for a portion including R¹ and the monomer serving as a raw material for a portion including R² may be the same monomer or may be different monomers. For example, after polymerizing the monomer serving as a raw material for a portion including A¹ and the monomer serving as a raw material for a portion including B, a monomer serving as a raw material for a portion including R¹ or R² and/or another monomer may be added and reacted by heating and mixing.

Examples of the monomer serving as a raw material for a portion including A¹ or A² include dihydroxyphenyl compounds such as hydroquinone, resorcinol, catechol, and phenylhydroquinone; bisphenol compounds such as 9,9-bis(4-hydroxyphenyl)fluorene, 9,9-bis(4-hydroxy-3-methylphenyl)fluorene, 9,9-bis(4-hydroxy-3-phenylphenyl)fluorene, 1,1-bis(4-hydroxyphenyl)-1-phenylethane, bis(4-hydroxyphenyl)diphenylmethane, 2,2-bis(4-hydroxyphenyl)propane, 2,2-bis(4-hydroxy-3-allylphenyl)propane, 2,2-bis(4-hydroxy-3-methylphenyl)propane, 2,2-bis(4-hydroxy-3-phenylphenyl)propane, 4,4′-(1,3-dimethylbutylidene)bisphenol, 1,1-bis(4-hydroxyphenyl)nonane. bis(4-hydroxyphenyl)sulfone, 1,1-bis(4-hydroxyphenyl)cyclohexane, 1,1-bis(4-hydroxyphenyl)-3,3,5-trimethylcyclohexane, 1,1-bis(3-methyl-4-hydroxyphenyl)-3,3,5-trimethylcyclohexane, 1,1-bis(3-cyclohexyl-4-hydroxyphenyl)-3,3,5-trimethylcyclohexane, 1,4-bis[2-(4-hydroxyphenyl)-2-propyl]benzene, 1,3-bis[2-(4-hydroxyphenyl)-2-propyl]benzene, 4,4′-cyclododecylidenebisphenol, and 4,4′-decylidenebisphenol; and diol compounds such as Priplast 1901, 1838, 3186, 3192, 3197, and 3199 (all are trade names, manufactured by Croda Japan K.K.). These monomers may be used alone, or two or more kinds thereof may be used.

Examples of the monomer serving as a raw material for a portion including B include pyrimidine compounds such as 4,6-dichloropyrimidine, 4,6-dibromopyrimidine, 2,4-dichloropyrimidine, 2,5-dichloropyrimidine, 2,5-dibromopyrimidine, 5-bromo-2-chloropyrimidine, 5-bromo-2-fluoropyrimidine, 5-bromo-2-iodopyrimidine, 2-chloro-5-fluoropyrimidine, 2-chloro-5-iodopyrimidine, 2-phenyl-4,6-dichloropyrimidine, 2-methylthio-4,6-dichloropyrimidine, 2-methylsulfonyl-4,6-dichloropyrimidine, 5-methyl-4,6-dichloropyrimidine, 2-amino-4,6-dichloropyrimidine, 5-amino-4,6-dichloropyrimidine, 2,5-diamino-4,6-dichloropyrimidine. 4-amino-2,6-dichloropyrimidine, 5-methoxy-4,6-dichloropyrimidine, 5-methoxy-2,4-dichloropyrimidine, 2-methyl-4,6-dichloropyriinidine, 6-methyl-2,4-dichloropyrimidine, 5-methyl-2,4-dichloropyrimidine, 5-nitro-2,4-dichloropyrimidine, 4-amino-2-chloro-5-fluoropyrimidine, 2-methyl-5-amino-4,6-dichloropyrimidine, and 5-bromo-4-chloro-2-methylthiopyrimidine; pyridazine compounds such as 3,6-dichloropyridazine, 3,5-dichloropyridazine, and 4-methyl-3,6-dichloropyridazine; and pyrazine compounds such as 2,3-dichloropyrazine, 2,6-dichloropyrazine, 2,5-dibromopyrazine, 2,6-dibromopyrazine, 2-amino-3,5-dibromopyrazine, and 5,6-dicyano-2,3-dichloropyrazine. These monomers may be used alone, or two or more kinds thereof may be used.

Examples of the monomer serving as a raw material for a portion including R¹ or R² include monovalent phenol compounds such as t-butylphenol, nonylphenol, 4-isopropenylphenol, 4-vinylphenol. 2-allylphenol, isoeugenol, tocotrienol, α-tocopherol, 4-hydroxyphenylmaleimide, and 2-phenylphenol; monovalent amine compounds such as 4-hexylaniline and diallylamine; monovalent thiol compounds such as 1-octanethiol; monovalent aliphatic halides such as allyl chloride, 4-(chloromethyl)styrene, and 3-(chloromethyl)styrene; monovalent acid halides such as acryloyl chloride. methacryloyl chloride, crotonyl chloride, and cinnamoyl chloride; and monovalent acid anhydrides such as acrylic anhydride, crotonic anhydride, and methacrylic anhydride. These monomers may be used alone, or two or more kinds thereof may be used.

Examples of other monomers include compounds that introduce a structural unit containing a carbonate bond, a thiocarbonate bond, or a selenocarbonate bond, such as diphenyl carbonate, diphenyl thiocarbonate, diphenyl selenocarbonate, phosgene, thiophosgene, and selenophosgene; dihydroxy compounds such as benzenedimethanol and cyclohexanedimethanol; phosphine oxide compounds such as bis(fluorophenyl)phenylphosphine oxide, bis(fluorophenyl)naphthylphosphine oxide, and bis(fluorophenyl) anthrylphosphine oxide; and dihalides of dicarboxylic acids such as phthalic acid dichloride, isophthalic acid dichloride, and terephthalic acid dichloride. These monomers may be used alone, or two or more kinds thereof may be used.

The alkali metal and the alkali metal compound react with a compound having a hydroxy group, such as a phenol compound, to form an alkali metal salt, when a compound having a hydroxy group is used as a raw material in the process of synthesizing the compound C.

Examples of such an alkali metal and alkali metal compound include:
alkali metals such as lithium, sodium, and potassium;
alkali metal hydrides such as lithium hydride, sodium hydride, and potassium hydride;
alkali metal hydroxides such as lithium hydroxide, sodium hydroxide, and potassium hydroxide;
alkali metal carbonates such as lithium carbonate, sodium carbonate, and potassium carbonate; and
alkali metal hydrogen carbonates such as lithium hydrogen carbonate, sodium hydrogen carbonate, and potassium hydrogen carbonate.

Among these, alkali metal carbonates are preferred, and potassium carbonate is more preferable.

When a compound having a hydroxy group is used in the synthesis of the compound C, the amount of the alkali metal and the alkali metal compound used is such that the lower limit of a ratio of the number of moles of alkali metal atoms to the number of moles of hydroxy groups in all compounds used in the synthesis of the compound C is preferably 1, more preferably 1.1, and still more preferably 1.2, and the upper limit of the ratio is preferably 3, more preferably 2, and still more preferably 1.8.

### Examples of the Organic Solvent Include

ether-based solvents such as tetrahydrofuran (THF), dioxane, cyclopentyl methyl ether, anisole, phenetole, diphenyl ether, dialkoxybenzene, and trialkoxybenzene;
nitrogen-containing solvents such as N,N-dimethylacetamide (DMAc), N,N-dimethylformamide, N-methyl-2-pyrrolidone, and 1,3-dimethyl-2-imidazolidinone;
ester-based solvents such as γ-butvrolactone;
sulfur-containing solvents such as sulfolane, dimethyl sulfoxide, diethyl sulfoxide, dimethyl sulfone, diethyl sulfone, diisopropyl sulfone, and diphenyl sulfone;
ketone-based solvents such as benzophenone, 2-heptanone, cyclohexanone, and methyl ethyl ketone;
halogen-based solvents such as methylene chloride, chloroform, and chlorobenzene; and
aromatic hydrocarbon-based solvents such as benzene, toluene, and xylene.

Among these organic solvents, 2-heptanone, cyclohexanone, N-methyl-2-pyrrolidone, toluene, and xylene are preferred, and N-methyl-2-pyrrolidone, 2-heptanone, and cyclohexanone are more preferable.

The reaction temperature during the synthesis is preferably 50° C. or higher, more preferably 80° C. or higher, and preferably 300° C. or lower, more preferably 200° C. or lower.

The reaction time during the synthesis is preferably 1 hour or longer, more preferably 2 hours or longer, still more preferably 3 hours or longer, and preferably 100 hours or shorter, more preferably 50 hours or shorter, still more preferably 24 hours or shorter.

From the viewpoint of suppressing gelation of the polymerization reaction solution, when a monomer serving as a raw material for a portion including R¹ or R² is added after polymerization, the reaction temperature is preferably 0° C. or higher, more preferably 10° C. or higher, and preferably 130° C. or lower, more preferably 110° C. or lower.

The reaction time when a monomer serving as a raw material for a portion including R¹ or R² is added after polymerization and reacted is preferably 1 hour or longer, more preferably 2 hours or longer, still more preferably 3 hours or longer, and preferably 48 hours or shorter, more preferably 24 hours or shorter, still more preferably 10 hours or shorter.

### <Prepreg>

A prepreg according to the present disclosure (hereinafter, also referred to as “the present prepreg”) contains the above-described present composition. The present prepreg can be produced, for example, by the following method. Specifically, first, the present composition to which the above-described other additives (elastomers, and curing agents such as crosslinking agents) are added as necessary is mixed and stirred to prepare a resin varnish. Next, the resin varnish is impregnated into a fibrous material and dried to obtain a prepreg.

Here, as the fibrous material into which the resin varnish is impregnated, a glass cloth having an arbitrary composition is preferably used from the viewpoints of processability and electrical properties, and a quartz cloth is more preferably used from the viewpoint of electrical properties.

### <Metal-Clad Laminate and Method for Producing the Same>

A metal-clad laminate according to the present disclosure (hereinafter, also referred to as “the present laminate”) includes a cured product of the above-described present composition and a metal foil. The present laminate can be obtained by laminating a prepreg containing the above-described present composition and a metal foil. More specifically, the present laminate can be produced by laminating metal foils (for example, copper foils) to both surfaces of a prepreg impregnated with the above-described present composition by lamination or the like, for example, under heating and pressurizing conditions.

The metal foil peel strength (peel strength) of a metal-clad laminate obtained by laminating, under heat and pressure, a prepreg obtained using the present composition and a metal foil is preferably 2.0 N/cm or more, and more preferably 2.5 N/cm or more, from the viewpoint of practical application.

### EXAMPLES

Hereinafter, the present disclosure will be described in more detail with reference to a plurality of examples; however, the present disclosure is not limited to these examples. Examples 1 to 23 are Examples according to the present disclosure, and Examples 24 to 27 are Comparative Examples.

### <Method for Structural Analysis>

In each example, the mixing ratios of the respective structures in the resin A, the compound B, and the compound C used were identified using ¹H-NMR and ³C-NMR.

### (1H-NMR)

The measurement target (for example, resin A) was dissolved in chloroform-di and measured by ¹H-NMR (manufactured by Bruker, trade name: Avance NEO400). At this time, tetramethylsilane was used as an internal standard substance. Peaks of hydrogen atoms derived from the α-olefin structure, the inner olefin structure, the terminal olefin, and the side-chain olefin in the present invention can be confirmed at 4.70 to 5.40 ppm.

### (¹³C-NMR)

The measurement target (for example, resin A) was dissolved in chloroform-di so as to have a concentration of 20 mass %, and measurement was performed by ¹³C-NMR (manufactured by JEOL Ltd., trade name: ECZ600). At this time, hexamethyldisiloxane was used as an internal standard substance. Spectral analysis was performed using Delta v6.0 (analysis software manufactured by JEOL Ltd.).

### (Calculation of Content of Each Structure in Resin A)

Peaks were assigned by two-dimensional NMR and the DEPT method. Specifically, baselines of respective peaks were drawn in ¹³C-NMR, and, based on an area a attributed to carbons of an inner olefin structure (area in the range of 16.8 to 18.2 ppm), an area b attributed to carbons of an indane structure (area in the range of 59.1 to 60.2 ppm), an area c attributed to carbons of an α-olefin structure and a terminal olefin structure and a side-chain olefin structure (area in the range of 114.3 to 118.1 ppm), an area d attributed to carbons of a terminal olefin structure and a side-chain olefin structure (area in the range of 21.6 to 22.3 ppm), an area e of an internal standard substance (area in the range of 1.4 to 2.5 ppm), and the amount f (grams) of hexamethyldisiloxane, the content of each structure (mmol/g) per 1 g of a target substance (resin A) was calculated from the amount g (grams) of the measurement target (resin A) by the calculation formula shown below.
Inner olefin content: a/(e/6)×f/162.38/g×1,000
Indane content: b/(e/6)×f/162.38/g×1,000
α-Olefin content: (c−d)/(e/6)×f/162.38/g×1,000
Terminal olefin and side-chain olefin content: d/(e/6)×f/162.38/g×1,000
FA=[content of α-olefin structure]/([content of inner olefin structure]+[content of indane structure]+[content of α-olefin structure])
FI=[content of indane structure]/([content of inner olefin structure]+[content of indane structure]+[content of α-olefin structure]/2)

### <Method for Measuring Iodine Value>

The iodine value of a measurement target (resin A) was measured by a method in accordance with JIS K 0070. Specifically, the measurement target was reacted with Wijs reagent (iodine monochloride-acetic acid solution) and allowed to stand in the dark, and thereafter, excess iodine monochloride was titrated with sodium thiosulfate to calculate the iodine value.

### <Method for Measuring Molecular Weight>

The weight average molecular weight Mw, the number average molecular weight Mn, and the molecular weight distribution (Mw/Mn) were measured using gel permeation chromatography (GPC) (manufactured by Tosoh Corporation, trade name: HLC-8420 GPC). As the columns, a guard column “HXL-L” (trade name, manufactured by Tosoh Corporation), “SuperH-RC” (trade name, manufactured by Tosoh Corporation), “TSKgel SuperHZ2000” (trade name, manufactured by Tosoh Corporation), “TSKgel SuperHZ2500” (trade name, manufactured by Tosoh Corporation), “TSKgel SuperHZ3000” (trade name, manufactured by Tosoh Corporation), and “TSKgel SuperHZ4000” (trade name, manufactured by Tosoh Corporation), connected in series were used. In addition, the measurement was performed using tetrahydrofuran as an eluent, a flow rate of 1.0 ml/min, a column temperature of 40° C., and an RI detector (differential refractometer), with a calibration curve prepared using monodisperse polystyrene. For data processing, “GPC Workstation EcoSEC-WorkStation” (trade name, manufactured by Tosoh Corporation) was used.

### <Measurement of Dielectric Loss Tangent (Df)>

A film-shaped cured product described below and a substrate obtained by removing a copper foil by etching from a copper-clad laminate for evaluation described below were used as test specimens, and the dielectric loss tangent (Df) at a frequency of 10 GHz was measured at room temperature (25° C.) by the SPDR method using a vector network analyzer (“E8361C” (trade name), manufactured by Agilent Technologies, Inc.). A measurement in a state without glass cloth was performed using a film-shaped cured product described below, and a measurement in a state with glass cloth was performed using the substrate obtained by removing the copper foil by etching from a copper-clad laminate for evaluation described below.

The dielectric loss tangent (Df) of the copper-clad laminate for evaluation was evaluated based on the following criteria.

### (Evaluation Criteria)

A+: 0.0015 or less
A: more than 0.0015 and 0.0025 or less
B: more than 0.0025 and 0.004 or less
C: more than 0.004

### <Preparation of Film-Shaped Cured Product>

The film-shaped cured product described above was prepared as follows. That is, 10 parts by mass of each of the resins obtained from Production Examples A1 to A8 described below and 2 parts by mass of BVPE were dissolved in 12 parts by mass of toluene. Next, the obtained toluene solution was poured between PTFE spacers, sandwiched between polyimide films, held with SUS plates, and cured by maintaining at a pressure of 2 MPa and 200° C. for 2 hours using a vacuum press, thereby obtaining a film-shaped cured product.

### (Production of Resin A)

### Production Example A

To a 1 L glass reaction vessel equipped with a stirring blade and a fluororesin-coated thermocouple under a flow of N2, 480 g of p-xylene, 4.80 g (33.8 mmol) of a boron trifluoride/diethyl ether complex (manufactured by Tokyo Chemical Industry Co., Ltd.) as an acid catalyst, and 6.91 g (67.6 mmol) of propyl acetate as a cocatalyst were added, and the mixture was maintained at 25° C. for 2 hours. Thereafter, while the reaction temperature was maintained at 50° C., 120.0 g of 1,3-diisopropenylbenzene (manufactured by Tokyo Chemical Industry Co., Ltd.) was added dropwise into the reaction vessel over 2 hours using a syringe pump. Further, after the dropwise addition, as an aging step, the reaction was performed for 15 minutes (aging time) while the temperature was maintained at 50° C. (aging temperature). Thereafter, 100 g of a 5 mass % aqueous sodium hydrogencarbonate solution was added into the reaction vessel to terminate the reaction. Subsequently, the aqueous phase in the reaction vessel was discarded, and liquid-liquid separation washing was performed three times with 300 m1 of ion-exchanged water to obtain a resin solution.

Subsequently, 2,200 g of methanol was added to a separate 6 L flask, and the resin solution was gradually added thereto to reprecipitate the resin. Thereafter, a resin cake was obtained by filtration. The resin cake was redispersed in 2,200 g of methanol, washed, and filtered, and this operation was performed twice. Thereafter, the obtained resin was vacuum-dried at 60° C. to obtain 107.9 g of a resin A-1.

Structural analysis, iodine value measurement, and molecular weight measurement of the obtained resin A-1 were performed in accordance with the methods described above. As a result, the molecular weights of the obtained resin A-1 were Mn: 1,770 and Mw: 7,090. In addition, the iodine value of the resin A-1 was 131. When the resin A-1 was dissolved in toluene so as to have a concentration of 60 mass %, no insoluble matter was generated. It was confirmed by ¹³C-NMR that the obtained resin A-1 had an α-olefin structure.

### Production Example A2

The same procedure as in Production Example A1 was performed, except that 0.96 g (6.76 mmol) of a boron trifluoride/diethyl ether complex was used, 1.38 g (13.5 mmol) of propyl acetate was used, the reaction temperature and the aging temperature were set to 37.5° C., and the aging time was set to 25 minutes, thereby obtaining 112.7 g of a resin A-2. Structural analysis, iodine value measurement, and molecular weight measurement of the obtained resin A-2 were performed in accordance with the methods described above. As a result, the molecular weights of the obtained resin A-2 were Mn: 2,260 and Mw: 19,130. In addition, the iodine value of the resin A-2 was 124. In addition, the contents of the respective structures in the obtained resin A-2 were as follows.

When the resin A-2 was dissolved in toluene so as to have a concentration of 60 mass %, no insoluble matter was generated.

Contents of the respective structures: α-olefin structure: 1.97 mmol/g, indane structure: 0.53 mmol/g, inner olefin structure: 0.16 mmol/g, terminal and side-chain olefin structures: 0.96 mmol/g

### Production Example A3

The same procedure as in Production Example A1 was performed, except that 0.96 g (6.76 mmol) of a boron trifluoride/diethyl ether complex was used, 1.38 g (13.5 mmol) of propyl acetate was used, the reaction temperature and the aging temperature were set to 37.5° C., and the aging time was set to 45 minutes, thereby obtaining 110.3 g of a resin A-3. Structural analysis, iodine value measurement, and molecular weight measurement of the obtained resin A-3 were performed in accordance with the methods described above. The results are as follows. When the resin A-3 was dissolved in toluene so as to have a concentration of 60 mass %, no insoluble matter was generated.
Molecular weights: Mn: 2,680, Mw: 40,683
Iodine value: 119
Contents of the respective structures: α-olefin structure: 2.18 mmol/g, indane structure: 0.53 mmol/g, inner olefin structure: 0.14 mmol/g, terminal and side-chain olefin structures: 0.62 mmol/g

### Production Example A4

The same procedure as in Production Example A1 was performed, except that 2.0 g (14.1 mmol) of a boron trifluoride/diethyl ether complex and 2.87 g (28.1 mmol) of propyl acetate were used, and the aging time was set to 60 minutes, thereby obtaining 98.1 g of a resin A-4. Structural analysis, iodine value measurement, and molecular weight measurement of the obtained resin A-4 were performed in accordance with the methods described above. The results are as follows. When the resin A-4 was dissolved in toluene so as to have a concentration of 60 mass %, no insoluble matter was generated.
Molecular weights: Mn: 2,460, Mw: 23,800
Iodine value: 114
Contents of the respective structures: α-olefin structure: 3.55 mmol/g, indane structure: 1.37 mmol/g, inner olefin structure: 0.14 mmol/g, terminal and side-chain olefin structures: 0.27 mmol/g

### Production Example A5

The same procedure as in Production Example A1 was performed, except that the aging time was set to 120 minutes, thereby obtaining 99.1 g of a resin A-5. Structural analysis, iodine value measurement, and molecular weight measurement of the obtained resin A-5 were performed in accordance with the methods described above. The results are as follows. When the resin A-5 was dissolved in toluene so as to have a concentration of 60 mass %, no insoluble matter was generated.
Molecular weights: Mn: 3,040, Mw: 35,720
Iodine value: 96
Contents of the respective structures: α-olefin structure: 2.25 mmol/g, indane structure: 1.03 mmol/g, inner olefin structure: 0.47 mmol/g, terminal and side-chain olefin structures: 0.07 mmol/g

### Production Example A6

The same procedure as in Production Example A1 was performed, except that the reaction temperature and the aging temperature were set to 55° C. and the aging time was set to 90 minutes, thereby obtaining 111.0 g of a resin A-6. Structural analysis, iodine value measurement, and molecular weight measurement of the obtained resin A-6 were performed in accordance with the methods described above. The results are as follows. When the resin A-6 was dissolved in toluene so as to have a concentration of 60 mass %, no insoluble matter was generated.
Molecular weights: Mn: 2,640, Mw: 20,900
Iodine value: 110
Contents of the respective structures: α-olefin structure: 2.50 mmol/g, indane structure: 0.89 mmol/g, inner olefin structure: 0.73 mmol/g, terminal and side-chain olefin structures: 0.15 mmol/g

### Production Example A7

The same procedure as in Production Example A1 was performed, except that the reaction temperature and the aging temperature were set to 75° C. and the aging time was set to 60 minutes, thereby obtaining 109.1 g of a resin A-7. Structural analysis, iodine value measurement, and molecular weight measurement of the obtained resin A-7 were performed in accordance with the methods described above. The results are as follows.
Molecular weights: Mn: 2,700, Mw: 15,530
Iodine value: 65
Contents of the respective structures: α-olefin structure: 1.61 mmol/g, indane structure: 2.00 mmol/g, inner olefin structure: 0.65 mmol/g, terminal and side-chain olefin structures: 0.07 mmol/g

### Production Example A8

Under a flow of N₂, 500 g of p-xylene and 17.5 g of p-toluenesulfonic acid monohydrate were added to a 1 L glass flask equipped with a thermometer and a stirrer, and the temperature was set to 60° C. While maintaining the reaction temperature at 60° C., 250 g of 1,3-diisopropenylbenzene (manufactured by TCI) was added dropwise over 2 hours. After completion of the dropwise addition, an aging reaction was performed at an aging temperature of 60° C. for 1 hour. After cooling, 160 g of water was added to dissolve and remove the catalyst. The reaction mixture was repeatedly washed with 160 g of water until it became neutral. Thereafter, the solvent and the monomer were distilled off under reduced pressure, thereby obtaining 136 g of a viscous resin A-8. Structural analysis, iodine value measurement, and molecular weight measurement of the obtained resin A-8 were performed in accordance with the methods described above. As a result, the molecular weights of the obtained resin A-8 were Mn: 390 and Mw: 570, and the iodine value was 210. When the obtained resin A-8 was analyzed by NMR, a peak of an isopropenyl group was confirmed in the region of 4.70 to 5.40 ppm in the ¹H-NMR chart.

The reaction conditions, molecular weights, contents of each structure, and the like of the respective resins obtained in Production Examples A1 to A8 are shown in Table 1. In addition, in accordance with the methods described above, the Df values of film-shaped cured products prepared using the respective resins were measured, and the results are shown in Table 1.

TABLE 1
Table 1

| Production example | | Example A1 | Example A2 | Example A3 | Example A4 | Example A5 | Example A6 | Example A7 | Example A8 |
|---|---|---|---|---|---|---|---|---|---|
| Reaction | Aging temperature | 50 | 37.5 | 37.5 | 50 | 50 | 55 | 75 | 60 |
| | (° C.) | | | | | | | | |
| conditions | Aging time (min) | 15 | 25 | 45 | 80 | 120 | 90 | 60 | 60 |
| Molecular | Number average | 1770 | 2260 | 2,680 | 2460 | 3040 | 2640 | 2700 | 390 |
| weight | molecular weight | | | | | | | | |
| | (Mn) | | | | | | | | |
| | Weight average | 7090 | 19130 | 40,883 | 23800 | 35720 | 20900 | 15530 | 570 |
| | molecular weight | | | | | | | | |
| | (Mw) | | | | | | | | |
| | Mw/Mn | 4.01 | 8.46 | 15.18 | 9.67 | 11.75 | 7.92 | 5.75 | 1.46 |
| Iodine value | | 131 | 124 | 119 | 114 | 96 | 110 | 65 | 210 |
| Content of | α-Olefin structure | 2.97 | 2.97 | 2.18 | 3.55 | 2.25 | 2.50 | 1.61 | 0.9 |
| each | Indane structure | 0.84 | 0.53 | 0.53 | 1.37 | 1.03 | 0.89 | 2.00 | 0.07 |
| structure | Inner olefin structure | 0.4 | 0.16 | 0.14 | 0.14 | 0.47 | 0.73 | 0.65 | 0.05 |
| [mmol/g] | Terminal and side- | 0.58 | 0.96 | 0.62 | 0.27 | 0.07 | 0.15 | 0.07 | 2.1 |
| | chain olefin structures | | | | | | | | |
| | α-Olefin structure + | 3.55 | 2.93 | 2.8 | 3.82 | 2.32 | 2.65 | 1.88 | 2.9 |
| | terminal and side- | | | | | | | | |
| | chain olefin structures | | | | | | | | |
| Parameter | FI | 0.31 | 0.32 | 0.30 | 0.42 | 0.39 | 0.31 | 0.58 | 0.12 |
| | FA | 0.71 | 0.74 | 0.76 | 0.70 | 0.60 | 0.61 | 0.38 | 0.88 |

| | | | | | | | | |
|---|---|---|---|---|---|---|---|---|
| Df of film-shaped oured product | 0.00062 | 0.00052 | 0.00052 | 0.00048 | 0.00044 | 0.00045 | 0.00051 | 0.00079 |

### (Production of Compound C)

### Production Example C1

Into a four-neck separable flask equipped with a stirring device, 1,1-bis(4-hydroxy-3-methylphenyl)-3,3,5-trimethylcyclohexane (33.85 g), 4,6-dichloro-2-phenylpyrimidine (16.65 g), and potassium carbonate (18.65 g) were charged, N-methyl-2-pyrrolidone (50.50 g) was added, and the mixture was reacted at 100° C. for 6 hours under a nitrogen atmosphere. After the reaction, while the vessel was cooled to 10° C., m,p-(chloromethyl)styrene (11.53 g) was added dropwise, and the mixture was reacted at 100° C. for 4 hours. The obtained reaction solution was diluted by adding N-methyl-2-pyrrolidone (55.0 g), salts were removed from the diluted solution by filtration, and the obtained solution was added to methanol (6,900 g). The precipitated solid was separated by filtration, washed with a small amount of methanol, and collected by filtration again, and then dried under reduced pressure at 60° C. for 12 hours using a vacuum dryer, thereby obtaining a polymer C-1 (compound C-1) represented by the following Formula (C-1). The polymer had a number average molecular weight (Mn) of 1,800 and a weight average molecular weight (Mw) of 4,000.

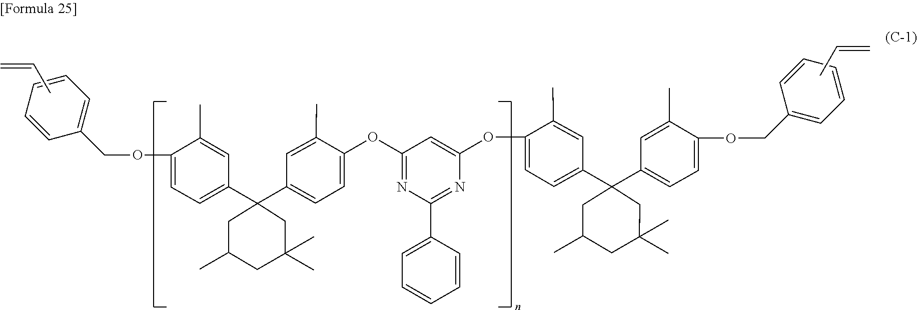

### Production Example C2

Into a four-neck separable flask equipped with a stirring device, 2,2-bis(4-hydroxy-3-methylphenyl)propane (26.43 g), 4,6-dichloro-2-phenylpyrimidine 25 (17.08 g), and potassium carbonate (19.23 g) were charged, N-methyl-2-pyrrolidone (42.50 g) was added, and the mixture was reacted at 100° C. for 6 hours under a nitrogen atmosphere. After the reaction, while the vessel was cooled to 10° C., m,p-(chloromethyl)styrene (11.53 g) was added dropwise, and the mixture was reacted at 100° C. for 4 hours. The obtained reaction solution was diluted by adding N-methyl-2-pyrrolidone (55.0 g), salts were removed from the diluted solution by filtration, and the obtained solution was added to methanol (6,900 g). The precipitated solid was separated by filtration, washed with a small amount of methanol, and collected by filtration again, and then dried under 5 reduced pressure at 60° C. for 12 hours using a vacuum dryer, thereby obtaining a polymer C-2 (compound C-2) represented by the following Formula (C-2). The polymer had a number average molecular weight (Mn) of 1,600 and a weight average molecular weight (Mw) of 3,200.

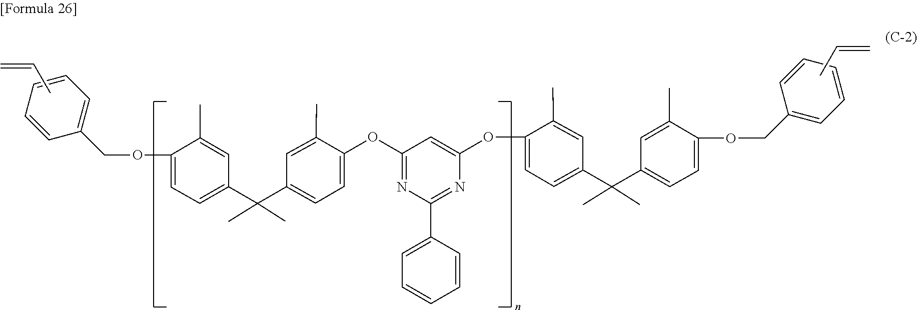

### Production Example C3

Into a four-neck separable flask equipped with a stirring device, 1,i-bis(4-hydroxyphenyl)-3,3,5-trimethylcyclohexane (57.95 g), 4,6-dichloropyrimidine 15 (31.72 g), isopropenylphenol (7.11 g), and potassium carbonate (33.77 g) were charged, N-methyl-2-pyrrolidone (42.67 g) was added, and the mixture was reacted at 130° C. for 6 hours under a nitrogen atmosphere. After completion of the reaction, N-methyl-2-pyrrolidone (240.0 g) was added to dilute the reaction mixture, the salts were removed by filtration, and the obtained solution was added 20 to methanol (12.9 kg). The precipitated solid was separated by filtration, washed with a small amount of methanol, and collected by filtration again, and then dried under reduced pressure at 120° C. for 12 hours using a vacuum dryer, thereby obtaining a polymer C-3 (compound C-3) represented by the following Formula (C-3). The polymer had a number average molecular weight (Mn) of 1,500 and a 25 weight average molecular weight (Mw) of 3,100.

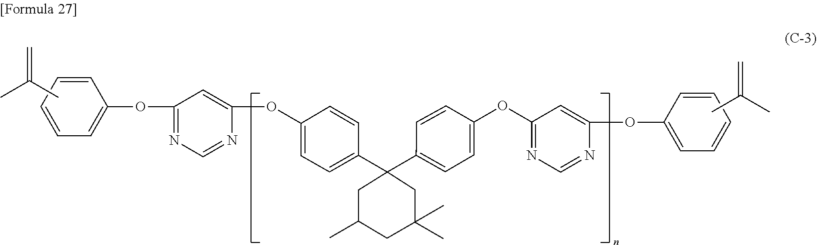

### [Production Example C4]

A polymer C-4 (compound C-4) represented by the following Formula (C-4) was synthesized in the same manner as in Production Example C3, except that the raw materials and the alkali metal compound used were changed to 2,2-bis(4-hydroxyphenyl)propane (30.4 g), isopropenylphenol (5.2 g), 4,6-dichloro-2-phenylpyrimidine (34.3 g), and potassium carbonate (24.0 g). The polymer had a number average molecular weight (Mn) of 1L500 and a weight average molecular 10 weight (Mw) of 3,100.

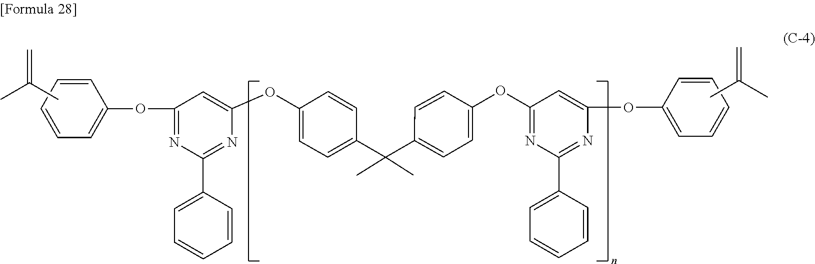

### Production Example C5

A polymer C-5 (compound C-5) represented by the following Formula (C-5) was synthesized in the same manner as in Production Example C3, except that the raw materials and the alkali metal compound used were changed to 1,1-bis(4-hydroxy-3-methylphenyl)-3,3,5-trimethylcyclohexane (36.1 g), 9,9-bis(4-hydroxy-3-methylphenyl)fluorene (10.1 g), 2,4-dichloro-6-phenyl-1,3,5-triazine (34.5 g), isopropenylphenol (5.2 g), potassium carbonate (24.0 g), and N-methyl-2-pyrrolidone (69.1 g). The polymer had a number average molecular weight (Mn) of 1,900 and a weight average molecular weight (Mw) of 4,100.

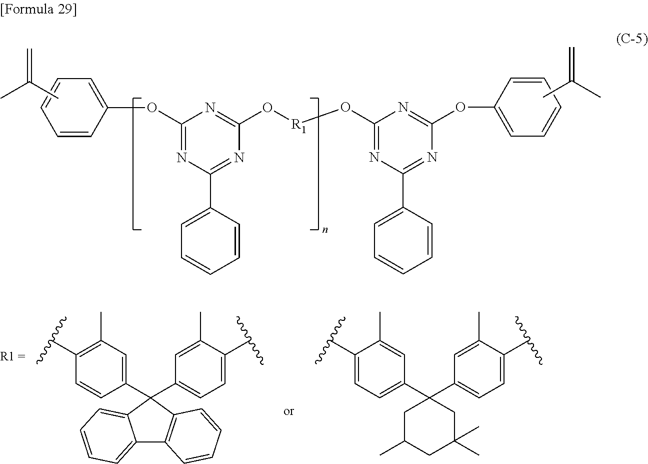

### Production Example C6

Into a four-neck separable flask equipped with a stirring device, 1,1-bis(4-hydroxy-3-methylphenyl)-3,3,5-trimethylcyclohexane (41.52 g), 9,9-bis(4-hydroxy-3-methylphenyl)fluorene (11.61 g), 2,4-dichloro-6-phenyl-1,3,5-triazine (3014 g), and potassium carbonate (26.18 g) were charged, N-methyl-2-pyrrolidone (42.67 g) was added, and the mixture was reacted at 130° C. for 6 hours under a nitrogen atmosphere. After the reaction, while the vessel was cooled to 10° C., methacryloyl chloride (4.06 g) was added dropwise, and the mixture was reacted at 50° C. for 6 hours. The obtained reaction solution was diluted by adding N-methyl-2-pyrrolidone (240.0 g), salts were removed from the diluted solution by filtration, and the obtained solution was added to methanol (12.90 kg). The precipitated solid was separated by filtration, washed with a small amount of methanol, and collected by filtration again, and then dried under reduced pressure at 120° C. for 12 hours using a vacuum dryer, thereby obtaining a polymer C-6 (compound C-6) represented by the following Formula (C-6). The polymer had a number average molecular weight (Mn) of 1,900 and a weight average molecular weight (Mw) of 4,100.

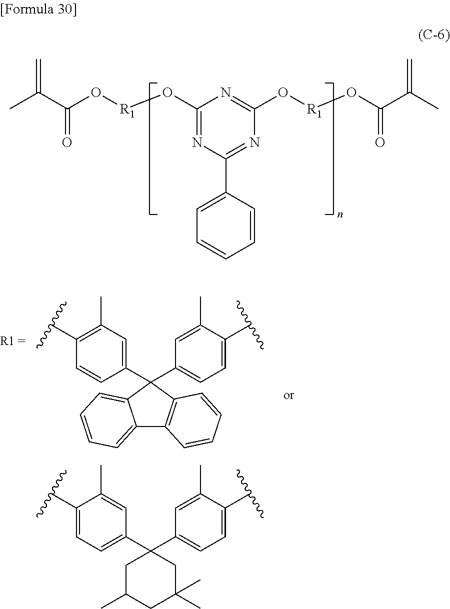

### Production Example C7

A polymer C-7 (compound C-7) represented by the following Formula (C-7) was synthesized in the same manner as in Production Example C1, except that the raw materials and the alkali metal compound used were changed to 1,1-bis(4-hydroxy-3-methylphenyl)-3,3,5-trimethyl cyclohexane (30.78 g), 9,9-bis(4-hydroxy-3-methylphenyl)fluorene (8.58 g), 2,4-dichloro-6-phenyl-1,3,5-triazine (20.18 g), m,p-chloromethylstyrene (10.0 g), potassium carbonate (22.1 g), and N-10 methyl-2-pyrrolidone (69.1 g). The polymer had a number average molecular weight (Mn) of 1,800 and a weight average molecular weight (Mw) of 4,000.

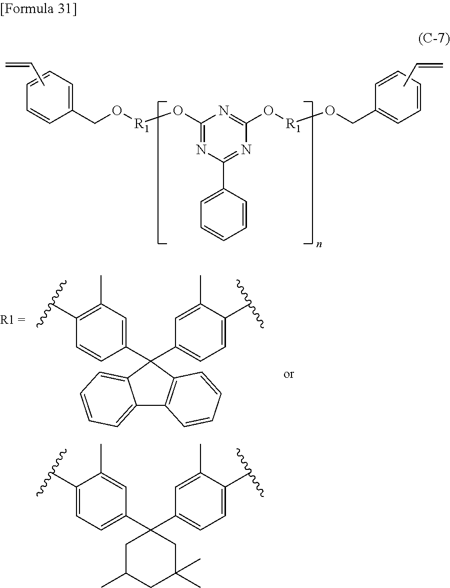

Next, using these resins A, compound B described below, and the above-described compound C and the like, a composition (resin varnish) and a metal-clad laminate were prepared in accordance with the following procedure, and the laminate was evaluated.

### <Preparation of Resin Varnish>

The resin A, the compound C, the elastomer, the crosslinking agent, and the initiator, which are described below, were dissolved in toluene so as to achieve a solid content of 50 mass %. Further, the following organophosphorus compound (compound B) and an inorganic filler were added to the obtained toluene solution, and mixed and dispersed using a rotor/stator-type mixer, thereby obtaining a resin varnish.
Resin A: the respective resins obtained in Production Examples A1 to A8
Compound C: the respective compounds obtained in Production Examples C1 to C7, a modified polyphenylene ether (trade name: SA-9000, manufactured by SABIC Innovative Plastics), a maleimide resin (trade name: NE-X 9470S, manufactured by DIC Corporation)
Elastomer: Tuftec H1043 (trade name, manufactured by Asahi Kasei Corporation)
Crosslinking agent: 1,2-bis(vinylphenyl)ethane (BVPE)
Initiator: CUROX (registered trademark)CC-DC (trade name, manufactured by United Initiators GmbH)
Inorganic filler: spherical silica EQ2410-SCM (trade name, manufactured by Zhejiang Third Age Material Technology Co., Ltd.)
Organophosphorus compound (compound B): ((1,4-phenylenedimethylene)bis(diphenylphosphine oxide)) (trade name: BES5-1150P, manufactured by Regina Electronics), [2-(diphenylphosphoryl)ethyl](diphenyl)phosphine oxide (trade name: VHP-4 dimer, manufactured by Osaka Gas Co., Ltd.), and SPV-100 (trade name, manufactured by Otsuka Chemical Co., Ltd.)

### <Preparation of Substrate for Evaluation>

The obtained resin varnish was used to impregnate a glass cloth (E-glass, #2116), which was then sandwiched between metal bars and drawn out to remove excess varnish, and then, drying was performed at room temperature (25° C.) for 10 minutes. Next, the impregnated glass cloth was dried in an air oven at 130° C. for 4 minutes to prepare a prepreg. At that time, the amount of the resin composition relative to the prepreg, that is, the resin content (R.C.), was adjusted to be 55 mass %. Two sheets of this prepreg were stacked, copper foils HS1-M2-VSP (trade name, manufactured by Mitsui Mining & Smelting Co., Ltd.) were placed on both surfaces thereof, and molding and curing were performed using a vacuum press molding machine to obtain substrates for evaluation (copper-clad laminates for evaluation) corresponding to Examples 1 to 22. The curing conditions were a pressure of 3 MPa and a temperature of 200° C. maintained for 90 minutes.

### <Evaluation of Flame Retardancy>

In the preparation of the substrates for evaluation shown in Examples 1 to 27, copper-clad laminates for evaluation were obtained in the same manner, except that twelve prepregs were stacked. The copper foils were removed from the obtained copper-clad laminates for evaluation by etching. Five specimens were prepared by cutting the resulting substrates into a size of 125 mm×13 mm. Each of these five samples was brought into contact with a flame for 10 seconds to observe the burning behavior.

The flame retardancy was evaluated in accordance with the following criteria.

### (Evaluation Criteria)

A+: The total burning time of the five samples is 30 seconds or shorter, and the burning time of each of the five samples is shorter than 10 seconds.
A: The total burning time of the five samples is longer than 30 seconds and 50 seconds or shorter, and the burning time of each of the five samples is shorter than 10 seconds.
B: The total burning time of the five samples is 50 seconds or shorter, and the burning time of one or more samples is 10 seconds or longer.
C: The total burning time of the five samples is longer than 50 seconds.

### <Measurement of Glass Transition Temperature Tg>

With respect to the glass transition temperature, a substrate obtained by removing a copper foil by etching from a copper-clad laminate for evaluation corresponding to each of Examples 1 to 27 prepared as described above was used as a test specimen, and dynamic mechanical analysis (DMA) was performed using a dynamic viscoelasticity measurement apparatus (“DVA-200” (trade name), manufactured by IT KEISOKU SEIGYO K.K.) to measure the glass transition temperature (Tg) (° C.). The measurement was performed under conditions of a frequency of 10 Hz, a heating rate of 2° C./min, and a temperature range of 25 to 300° C.

The Tg was evaluated in accordance with the following criteria.

### (Evaluation Criteria)

A+: 200° C. or higher
A: 175° C. or higher and lower than 200° C.
B: 150° C. or higher and lower than 175° C.
C: lower than 150° C.

The measurement results are shown in Tables 2 to 4.

### <Copper Foil Peel Strength: Measurement of Peel Strength>

From the prepared copper-clad laminates for evaluation shown in Examples 1 to 27, a test specimen having a width of 20 mm and a length of 100 mm was cut out, and parallel cuts having a width of 10 mm were made on the copper foil surface. Thereafter, the copper foil was continuously peeled at a rate of 50 mm/mIn in a direction of 900 with respect to the copper foil surface, the stress at that time was measured using a tensile testing machine, and the minimum value of the stress was recorded as the copper foil peel strength (in accordance with JIS C 6481).

The copper peel strength was evaluated based on the following criteria.

### (Evaluation Criteria)

A+: 4 N/cm or more
A: 3 N/cm or more and less than 4 N/cm
B: 2 N/cm or more and less than 3 N/cm
C: less than 2 N/cm

The measurement results are shown in Tables 2 to 4.

TABLE 2
Table 2

| | | Example | Example | Example | Example | Example | Example | Example | Example | Example | Example | Example |
|---|---|---|---|---|---|---|---|---|---|---|---|---|
| | | 1 | 2 | 3 | 4 | 5 | 6 | 7 | 8 | 9 | 10 | 11 |
| Resin A | Production | 14.8 | — | — | — | — | — | — | — | — | — | — |
| | Example A1 | | | | | | | | | | | |
| | Production | — | 14.8 | — | — | — | — | — | — | — | — | — |
| | Example A2 | | | | | | | | | | | |
| | Production | — | — | 14.8 | — | — | — | — | — | — | — | — |
| | Example A3 | | | | | | | | | | | |
| | Production | — | — | — | 14.8 | — | — | — | — | 17.8 | 20.8 | 23.7 |
| | Example A4 | | | | | | | | | | | |
| | Production | — | — | — | — | 14.8 | — | — | — | — | — | — |
| | Example A5 | | | | | | | | | | | |
| | Production | — | — | — | — | — | 14.8 | — | — | — | — | — |
| | Example A6 | | | | | | | | | | | |
| | Production | — | — | — | — | — | — | 14.8 | — | — | — | — |
| | Example A7 | | | | | | | | | | | |
| | Production | — | — | — | — | — | — | — | 14.8 | — | — | — |
| | Example A8 | | | | | | | | | | | |
| Compound C | Production | 14.8 | 14.8 | 14.8 | 14.8 | 14 8 | 14.8 | 14.8 | 14.8 | 11.9 | 8.9 | 5.9 |
| | Example C1 | — | — | — | — | — | — | — | — | — | — | — |
| | Production | — | — | — | — | — | — | — | — | — | — | — |
| | Example C2 | — | — | — | — | — | — | — | — | — | — | — |
| | Production | — | — | — | — | — | — | — | — | — | — | — |
| | Example C3 | — | — | — | — | — | — | — | — | — | — | — |
| | Production | — | — | — | — | — | — | — | — | — | — | — |
| | Example C4 | — | — | — | — | — | — | — | — | — | — | — |
| | Production | — | — | — | — | — | — | — | — | — | — | — |
| | Example C5 | — | — | — | — | — | — | — | — | — | — | — |
| | Production | — | — | — | — | — | — | — | — | — | — | — |
| | Example C6 | — | — | — | — | — | — | — | — | — | — | — |
| | Production | — | — | — | — | — | — | — | — | — | — | — |
| | Example C7 | — | — | — | — | — | — | — | — | — | — | — |
| | SA-9000 | — | — | — | — | — | — | — | — | — | — | — |
| | NE-X 94708 | — | — | — | — | — | — | — | —. | — | — | — |
| Crosslinking | BVPE | 1.0 | 1.0 | 1.0 | 1.0 | 1.0 | 1.0 | 1.0 | 1.0. | 1.0 | 1.0 | 1.0 |
| agent | | | | | | | | | | | | |
| Elastomer | Tuftec H1043 | 4.4 | 4.4 | 4.4 | 4.4 | 4.4 | 4.4 | 4.4 | 4.4 | 4.4 | 4.4 | 4.4 |
| initiator | CC-DC | 0.6 | 0.6 | 0.6 | 0.6 | 0.6 | 0.6 | 0.6 | 0.6 | 0.6 | 0.6 | 0.6 |
| Filler | EQ2410-SCM | 46.7 | 46.7 | 46.7 | 46.7 | 46.7 | 46.7 | 46.7 | 46.7 | 46.7 | 46.7 | 46.7 |
| Compound B | BES-1150P | 17.6 | 17.6 | 17.6 | 17.6 | 17.6 | 17.6 | 17.6 | 17.6 | 17.6 | 17.6 | 17.6 |
| | VHP4-dimer | — | — | — | — | — | — | — | — | — | — | — |
| | SPV-100 | — | — | — | — | — | — | — | — | — | — | — |
| Halogen | SAYTEX8010 | — | — | — | — | — | — | — | — | — | — | — |
| material | | | | | | — | — | — | — | — | — | — |

| | | | | | | | | | | | |
|---|---|---|---|---|---|---|---|---|---|---|---|
| Content ratio of oxygen atoms | 7.2% | 7.2% | 7.2% | 7.2% | 7.2% | 7.2% | 7.2% | 7.2% | 6.6% | 5.9% | 5.2% |
| and nitrogen atoms contained | | | | | | | | | | | |
| in organic material | | | | | | | | | | | |
| DI | A | A+ | A+ | A+ | A+ | A+ | A+ | A+ | A+ | A+ | A+ |
| Flame retardancy | A | A+ | A+ | A+ | A+ | A+ | A+ | A+ | A+ | A+ | A+ |
| Tg | B | A+ | A+ | A+ | A+ | A+ | A+ | A+ | A+ | A+ | A+ |
| Copper peel strength (N/cm) | B | A+ | A+ | A+ | A+ | A+ | A | B | A+ | A+ | A+ |

TABLE 3
Table 3

| | | Example 12 | Example 13 | Example 14 | Example 15 | Example 16 | Example 17 | Example 18 | Example 19 | Example 20 | Example 21 | Example 22 | Example 23 |
|---|---|---|---|---|---|---|---|---|---|---|---|---|---|
| Resin A | Production | — | — | — | — | — | — | — | — | — | — | — | — |
| | Example A1 | | | | | | | | | | | | |
| | Production | — | — | — | — | — | — | — | — | — | — | — | — |
| | Example A2 | | | | | | | | | | | | |
| | Production | — | — | — | — | — | — | — | — | — | — | — | — |
| | Example A3 | | | | | | | | | | | | |
| | Production | 26.7 | 14.8 | 14.8 | 14.8 | 14.8 | 14.8 | 14.8 | 14.8 | 14.8 | 14 8 | 14.8 | 14.8 |
| | Example A4 | | | | | | | | | | | | |
| | Production | — | — | — | — | — | — | — | — | — | — | — | — |
| | Example A5 | | | | | | | | | | | | |
| | Production | — | — | — | — | — | — | — | — | — | — | — | — |
| | Example A6 | | | | | | | | | | | | |
| | Production | — | — | — | — | — | — | — | — | — | — | — | — |
| | Example A7 | | | | | | | | | | | | |
| | Production | — | — | — | — | — | — | — | — | — | — | — | — |
| | Example A8 | | | | | | | | | | | | |
| Compound C | Production | 3.0 | — | — | — | — | — | — | — | — | — | — | 14.8 |
| | Exemple C1 | | | | | | | | | | | | |
| | Production | — | 14.8 | — | — | — | — | — | — | — | 14.8 | 14.8 | — |
| | Example C2 | | | | | | | | | | | | |
| | Production | — | — | 14.8 | — | — | — | — | — | — | — | — | — |
| | Example C3 | | | | | | | | | | | | |
| | Production | — | — | — | 14.8 | — | — | — | — | — | — | — | — |
| | Example C4 | | | | | | | | | | | | |
| | Production | — | — | — | — | 14.8 | — | — | — | — | — | — | — |
| | Example C5 | | | | | | | | | | | | |
| | Production | — | — | — | — | — | 14.8 | — | — | — | — | — | — |
| | Example C6 | | | | | | | | | | | | |
| | Production | — | — | — | — | — | — | 14.8 | — | — | — | — | — |
| | Example C7 | | | | | | | | | | | | |
| | SA-9000 | — | — | — | — | — | — | — | 14.8 | — | — | — | — |
| | NE-X 94705 | — | — | — | — | — | — | — | — | 14.8 | — | — | — |
| Crosslinking | BVPE | 1.0 | 1.0 | 1.0 | 1.0 | 1.0 | 1.0 | 1.0 | 1.0 | 1.0 | 1.0 | 1.0 | 1.0 |
| agent | | | | | | | | | | | | | |
| Elastomer | Tuftec H1043 | 4.4 | 4.4 | 4.2 | 4.4 | 4.4 | 4.4 | 4.4 | 4.4 | 4.4 | 4.4 | 4.4 | 4.4 |
| Initiator | CC-DC | 0.6 | 0.6 | 0.6 | 0.6 | 0.6 | 0.6 | 0.6 | 0.6 | 0.6 | 0.6 | 0.6 | 0.6 |
| Filler | EQ2410-SCM | 46.7 | 46.7 | 46.7 | 46.7 | 46.7 | 46.7 | 46.7 | 46.7 | 46.7 | 46.7 | 46.7 | 46.7 |
| Compound B | BES-1150P | 17.6 | 17.6 | 17.6 | 17.6 | 17.6 | 17.6 | 17.6 | 17.6 | 17.6 | | | 8.8 |
| | VHP4-dimer | — | — | — | — | — | — | — | — | — | 17.6 | — | — |
| | SPV-100 | — | — | — | — | — | — | — | — | — | — | 17.6 | — |
| Halogen | SAYTEX8010 | — | — | — | — | — | — | — | — | — | — | — | 8.8 |
| material | | | | | | | | | | | | | |

| | | | | | | | | | | | | |
|---|---|---|---|---|---|---|---|---|---|---|---|---|
| Content ratio of oxygen atoms | 4.5% | 7.8% | 7.3% | 8.0% | 7.7% | 8.3% | 7.8% | 7.8% | 6.7% | 6.1% | 9.3% | 5.2% |
| and nitrogen atoms contained | | | | | | | | | | | | |
| in organic motertal | | | | | | | | | | | | |
| Df | A+ | A+ | A+ | A+ | A+ | A | A+ | B | B | B | B | A+ |
| Flame retardency | B | A+ | A+ | A+ | A+ | A+ | A+ | A+ | A+ | A | A+ | A+ |
| Tg | A+ | A | A | A | A | A+ | A+ | A | A | B | B | A+ |
| Copper peel strength [N/cm] | A+ | A+ | A+ | A+ | A | A+ | A+ | A+ | A+ | A | B | A+ |

TABLE 4

| | | Example 24 | Example 25 | Example 26 | Example 27 |
|---|---|---|---|---|---|
| Resin A | Production Example A1 | — | — | — | — |
| | Production Example A2 | — | — | — | — |
| | Production Example A3 | — | — | — | — |
| | Production Example A4 | 29.6 | — | 14.8 | 29.6 |
| | Production Example A5 | — | — | — | — |
| | Production Example A6 | — | — | — | — |
| | Production Example A7 | — | — | — | — |
| | Production Example AB | — | — | — | — |
| Compound C | Production Example C1 | — | 29.6 | 14.8 | — |
| | Production Example C2 | — | — | — | — |
| | Production Example C3 | — | — | — | — |
| | Production Example C4 | — | — | — | — |
| | Production Example C5 | — | — | — | — |
| | Production Example C6 | — | — | — | — |
| | Production Example C7 | — | — | — | — |
| | SA-9000 | — | — | — | — |
| | NE-X 9470S | — | — | — | — |
| Crosslinking agent | BVPE | 1.0 | 1.0 | 1.0 | 1.0 |
| Elastomer | Tuftec H1043 | 4.4 | 4.4 | 4.4 | 4.4 |
| Initiator | CC-DC | 0.6 | 0.6 | 0.6 | 0.6 |
| Filler | EQ2410-SCM | 46.7 | 46.7 | 46.7 | 46.7 |
| Compound B | BES-1150P | 17.6 | 17.6 | — | — |
| | VHP4-dimer | — | — | — | — |
| | SPV-100 | — | — | — | — |
| Halogen material | SAYTEX8010 | — | — | — | 17.6 |

| | | | | |
|---|---|---|---|---|
| Content ratio of oxygen atoms and nitrogen | 3.9% | 10.5% | 3.3% | 0.0% |
| atoms contained in organic material | | | | |
| Df | A+ | C | A | A+ |
| Flame retardancy | C | A+ | C | A+ |
| Tg | A | A+ | A | C |
| Copper peel strength [N/cm] | B | A+ | A+ | A |

From the above, it was found that the present composition has a low dielectric loss tangent, is excellent in flame retardancy, satisfies practical properties in a well-balanced manner, and is excellent as a substrate material.

From the above, it can be seen that the present composition containing the above-described resin A, compound B, and compound C has excellent electrical properties and flame retardancy. In addition, the present disclosure can provide electronic materials with excellent electrical properties, flame retardancy, and the like, such as the present composition, a cured product using the present composition, a prepreg, and a metal-clad laminate.

It should be noted that the present disclosure is not limited to the above-described embodiments, and various modifications can be made without departing from the spirit thereof. In addition, the present disclosure may be implemented by appropriately combining the above-described embodiments and examples thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A resin composition comprising at least a resin having an α-olefin structure represented by the following Formula (1), an organophosphorus compound, and a compound having at least one atom selected from the group consisting of an oxygen atom and a nitrogen atom, 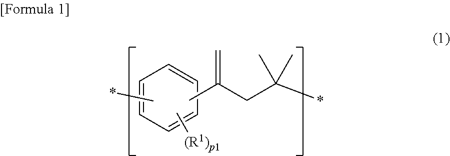
in Formula (1), each R¹ independently represents a C1-C10 hydrocarbon group or a halogenated alkyl group, p1 represents an integer of 0 to 4, and each * represents a bonding position.

2. The resin composition according to claim 1, wherein an iodine value of the resin is 70 or more and 200 or less.

3. The resin composition according to claim 1, wherein a weight average molecular weight Mw of the resin is 2,500 or more and 500,000 or less.

4. The resin composition according to claim 1, wherein a content of the α-olefin structure represented by Formula (1) in the resin is 1.0 mmol/g or more and 6.3 mmol/g or less.

5. The resin composition according to claim 1, wherein the following parameter FA represented by a content of the α-olefin structure represented by Formula (1), a content of an indane structure represented by the following Formula (2), and a content of an inner olefin structure represented by the following Formula (3) in the resin is 0.39 or more,
FA=[content of α-olefin structure]/([content of inner olefin structure]+[content of indane structure]+[content of α-olefin structure]), 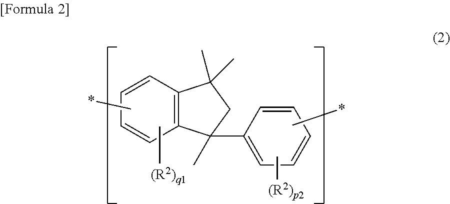
in Formula (2), each R² independently represents a C1-C10 hydrocarbon group or a halogenated alkyl group, p2 represents an integer of 0 to 4, q1 represents an integer of 0 to 3, and each * represents a bonding position, 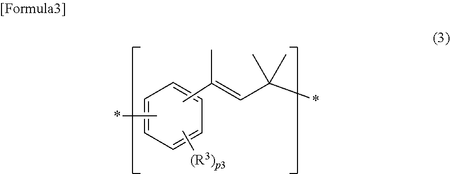
in Formula (3), each R³ independently represents a C1-C10 hydrocarbon group or a halogenated alkyl group, p3 represents an integer of 0 to 4, and each * represents a bonding position.

6. The resin composition according to claim 1, wherein the following parameter FI represented by a content of the α-olefin structure represented by Formula (1), a content of an indane structure represented by the following Formula (2), and a content of an inner olefin structure represented by the following Formula (3) in the resin is less than 0.58,
FI=[content of indane structure]/([content of inner olefin structure]+[content of indane structure]+[content of α-olefin structure]/2), 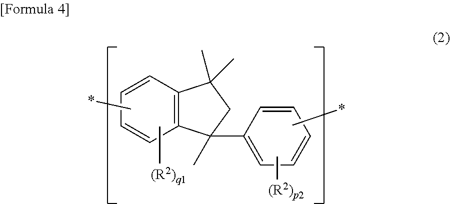
in Formula (2), each R² independently represents a C1-C10 hydrocarbon group or a halogenated alkyl group, p2 represents an integer of 0 to 4, q1 represents an integer of 0 to 3, and each * represents a bonding position, 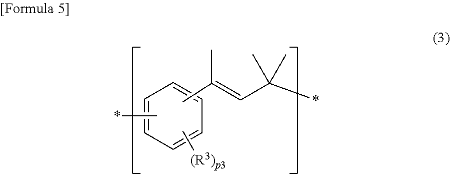
in Formula (3), each R³ independently represents a C1-C10 hydrocarbon group or a halogenated alkyl group, p3 represents an integer of 0 to 4, and each * represents a bonding position.

7. The resin composition according to claim 1, wherein the resin has an olefin structure at a terminal.

8. The resin composition according to claim 1, wherein the resin further has a side-chain olefin structure having an olefin structure in a side-chain portion.

9. The resin composition according to claim 1, wherein a total content of the α-olefin structure, an olefin structure at a terminal, and a side-chain olefin structure having an olefin structure in a side-chain portion in the resin is 1.8 mmol/g or more.

10. The resin composition according to claim 1, wherein a content of an indane structure represented by the following Formula (2) in the resin is 3.0 mmol/g or less, 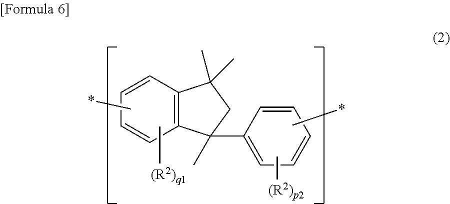
in Formula (2), each R² independently represents a C1-C10 hydrocarbon group or a halogenated alkyl group, p2 represents an integer of 0 to 4, q1 represents an integer of 0 to 3, and each * represents a bonding position.

11. The resin composition according to claim 1, wherein the organophosphorus compound has a solubility of 5 g or less in 100 g of toluene at 25° C.

12. The resin composition according to claim 1, wherein the organophosphorus compound is incompatible with the resin.

13. The resin composition according to claim 1, wherein a melting point of the organophosphorus compound is 240° C. or higher.

14. The resin composition according to claim 1, wherein the organophosphorus compound has a phosphine oxide structure or a phosphinic acid structure.

15. The resin composition according to claim 1, wherein a number average molecular weight Mn of the compound having at least one atom selected from the group consisting of an oxygen atom and a nitrogen atom is 300 to 50,000.

16. The resin composition according to claim 1, wherein the compound having at least one atom selected from the group consisting of an oxygen atom and a nitrogen atom contains a radical-polymerizable group.

17. The resin composition according to claim 1, wherein a total content of oxygen atoms and nitrogen atoms is 0.01 to 10 mass %.

18. The resin composition according to claim 1, wherein, based on the solid content of the resin composition, a content of the resin is 1 to 80 mass %, a content of the organophosphorus compound is 0.1 to 30 mass %, and a content of the compound having at least one atom selected from the group consisting of an oxygen atom and a nitrogen atom is 1 to 80 mass %.

19. A prepreg comprising the resin composition according to claim 1.

20. A metal-clad laminate comprising a cured product of the resin composition according to claim 1 and a metal foil.
